(19) United States
(12) Patent Application Publication
(10) Pub. No.: US 2003/0126098 A1
(43) Pub. Date: Jul. 3, 2003

(54) Methods and systems for equipment lease processing and management

(76) Inventors: Theodore W. Hine, Chicago, IL (US); Susan Bauer, Tigard, OR (US); Martin Lewandowski, Tualatin, OR (US); Selma Lower, Ridgefield, WA (US); Craig Cochran, Gresham, OR (US); Kirby Miller, Centerville, OH (US); Mark Jorgensen, Hillsboro, OR (US); Steve Choban, Hillsboro, OR (US); Jodi Chrisman, Sherwood, OR (US)

Correspondence Address: John S. Beulick, Armstrong Teasdale LLP, One Metropolitan Sq., Suite 2600, St. Louis, MO, 63102, US

(21) Appl. No.: 10/038,789

(22) Filed: Dec. 31, 2001

(51) Int. Cl. G06F 17/60; G06G 7/00; G06F 17/00

(52) U.S. Cl. 705/400; 705/1; 705/30; 705/35

(57) ABSTRACT

A method for equipment lease processing and management, using a network-based system and at least one client system configured to communicate with the network-based system. The method includes providing a lease application on the network-based system, the lease application configured to be completed using the client system, and submitted to the network using the client system. The method also includes processing a completed lease application using the network based system, and displaying on the client system the results of said processing of the completed lease application, using the network-based system.

### BACKGROUND OF THE INVENTION

This invention relates generally to equipment leasing, and more particularly to supporting equipment vendors and manufacturers, and providing customers with leasing alternatives.

Management and processing of equipment leases can be difficult and time consuming, particularly when multiple parties are involved. For example, equipment leases may involve customers, equipment vendors, equipment manufacturers, and equipment brokers. These parties need to track and manage their lease transactions, and their respective accounts, including their company or individual profile, financial information, and lease rate information. Typically, management of lease transactions and account information, and processing of new lease applications and new company and individual accounts, is manual, via telephone, fax or regular mail. Manual account and lease transaction management can be difficult and extremely time consuming, typically requiring a human operator or administrator. Further, manual lease processing may increase credit approval time for new lease transactions, thereby increasing cycle time for lease approval. An increased cycle time may also facilitate errors in the lease origination process.

### BRIEF DESCRIPTION OF THE INVENTION

In one aspect, a method is provided for equipment lease processing and management, using a network-based system and at least one client system configured to communicate with the network-based system. The method includes providing a lease application on the network-based system, the lease application configured to be completed using the client system, and submitted to the network using the client system, processing a completed lease application using the network based system, and displaying on the client system the results of said processing of the completed lease application, using the network-based system.

In another aspect, a method is provided for equipment lease processing and management, using a network-based system and at least two client systems configured to communicate with the network-based system. The method includes providing a lease application on the network-based system wherein the lease application is configured to be partially completed using a first client system, and submitted to the network-based system using the first client system. The system is also configured to electronically mail notification to a customer that a vendor has submitted a partially completed lease application to the network-based system, wherein the electronic mail notification includes a link configured to access the partially completed lease application and submit a fully completed application to the network-based system, using a second client system. The method further includes requiring the customer validate and complete the partially completed lease application using the second client system, and processing the completed application using the network-based system.

In another aspect, a method is provided for equipment lease processing and management, using a network-based system and at least one client system configured to communicate with the network-based system. The network-based system includes a database. The method includes storing user names, user passwords, and user profiles in the database, requiring a user to enter a valid user name and a valid user password to access the network-based system, comparing an entered user name and an entered user password with user names and user passwords stored in the database to determine a user's profile, and providing access, using the network-based system, to user accounts and user profiles on the client system such that the user can view and modify the user accounts and user profiles using the client system.

In yet another aspect, a system is provided which comprises at least one computer configured as a server, wherein the server contains a centralized database. The system further includes at least one client system connected to the server through a network. The client system is configured with a browser. The centralized database contains user names, user passwords, user profiles, user accounts, and lease transaction information, wherein the user names, user passwords, and user profiles include vendor names, vendor passwords, and vendor profiles. The server is configured to require a vendor to enter a valid vendor name and a valid vendor password to access the server and the centralized database, compare an entered vendor name and an entered vendor password with vendor names and vendor passwords stored in the centralized database to determine a vendor's profile, and allow the vendor to view and modify the user accounts, user profiles, and lease transaction information on the client system using the browser. The ability of a vendor to view the user accounts, user profiles, and lease transaction information depends on the vendor's profile. Further, the ability of a vendor to modify the user accounts, user profiles, and lease transaction information depends on the vendor's profile.

In a further aspect, a system for lease management by a client is provided. The system comprises at least one computer configured as a server, wherein the server contains a centralized database, and at least one client system connected to the server through a network, wherein the client system is configured with a browser. The centralized database contains client names, client passwords, client profiles, client accounts, and lease transaction information. The client includes a plurality of users and the centralized database includes a plurality of user names, user passwords, user profiles, and user accounts for the client. The server is configured to require a user to enter a valid user name and a valid user password into the client system to access the server and the centralized database, compare an entered user name and an entered user password with user names and user passwords stored in the centralized database for the client, to determine a user's profile, and allow the user to manage lease transactions, lease accounts, user accounts, and user profiles on the client system using the browser, wherein the level of management the user is allowed by the server depends on the user's profile.

In yet a further aspect, a computer readable medium is provided which comprises a centralized database having user names, user passwords, and user profiles stored in the database, a code segment that requires a user to enter a valid user name and a valid user password to access the database, and a code segment that compares an entered user name and an entered user password with user names and user passwords stored in the database to determine a user's profile. The computer readable medium further comprises a code segment that provides access to the user accounts and the user profiles such that the user can view and modify the user accounts and the user profiles, wherein the user's level of access to the user accounts and the user profiles is determined by the user's profile.

In another aspect, a computer program is provided for a network-based system for equipment lease processing and management. The network-based system includes a server, a client system, and a centralized database coupled to the server. The server is configured to communicate with the client system. The computer program includes a lease application stored in the centralized database and configured to be completed using the client system. The lease application is further configured to be submitted to the server using the client system. The computer program further includes a code segment to process the completed lease application using the server, and a code segment to display on the client system the results of said processing of the completed lease application.

In another aspect, a computer program is provided for a network-based system for equipment lease processing and management. The network-based system includes a server, at least two client systems, and a centralized database coupled to the server. The server is configured to communicate with the client system. The centralized database includes vendor names, vendor passwords, and vendor profiles stored in the database. The computer program includes a code segment to require the vendor to enter into a first client system a valid vendor name and a valid vendor password to access the centralized database and the lease application, a code segment to compare the vendor name and vendor password entered into the client system with vendor names and vendor passwords stored in the centralized database to determine a vendor's profile, and a lease application code segment stored in the centralized database and configured to be at least partially completed using the first client system. The partially completed lease application is further configured to be submitted to the server using the first client system. The computer program further comprises a code segment to electronically mail notification to a customer that a vendor has submitted a partially completed lease application to the server, wherein the electronic mail notification includes a link configured to access the partially completed lease application and submit a fully completed lease application to the server, using a second client system. The computer program further includes a code segment to allow the customer to validate and complete the partially completed lease application using the second client system, and a code segment to process the completed lease application using the server.

### BRIEF DESCRIPTION OF THE DRAWINGS

FIG. 1 is a simplified block diagram illustrating one embodiment of a lease transaction system for equipment lease management and processing.

FIG. 2 is an expanded version block diagram of one embodiment of server architecture of a lease transaction system.

FIG. 3 is a flowchart illustrating one embodiment of a method for equipment lease processing and management using a lease transaction system.

FIG. 4 is a flowchart illustrating one embodiment of a method for equipment lease processing and management using a lease transaction system.

FIG. 5 is a flowchart illustrating one embodiment of a method for equipment lease processing and management using a lease transaction system.

FIG. 6 is a flowchart illustrating one embodiment of a method for equipment lease processing and management using a lease transaction system.

FIG. 7 is a flowchart illustrating one embodiment of a method for equipment lease processing and management using a lease transaction system.

FIG. 8 is a flowchart illustrating one embodiment of a method for allowing a user to manage a user's lease transactions, lease accounts, user accounts, and user profile.

FIG. 9 is a flowchart illustrating one embodiment of a method for client lease management.

FIG. 10 is a flowchart illustrating one embodiment of a method for equipment lease processing and management using a lease transaction system.

FIG. 11 is a flowchart illustrating one embodiment of a method for equipment lease processing and management using a lease transaction system.

FIG. 12 is a flowchart illustrating one embodiment of a method for equipment lease processing and management using a lease transaction system.

FIG. 13 is a flowchart illustrating one embodiment of a method for equipment lease processing and management using a lease transaction system.

FIG. 14 is a flowchart illustrating one embodiment of a method for equipment lease processing and management using a lease transaction system.

FIG. 15 is a flowchart illustrating one embodiment of a method for equipment lease processing and management using a lease transaction system.

FIG. 16 is an example of a login user interface for one embodiment of a lease transaction system.

FIG. 17 is an example of a user registration interface for one embodiment of a lease transaction system.

FIG. 18 is an example of a user registration interface for one embodiment of a lease transaction system.

FIG. 19 is an example of a user registration notification interface for one embodiment of a lease transaction system.

FIG. 20 is an example of a user forgot password interface for one embodiment of a lease transaction system.

FIG. 21 is an example of a user new password interface for one embodiment of a lease transaction system.

FIG. 22 is an example of a main user interface for one embodiment of a lease transaction system.

FIG. 23 is an example of a main vendor interface for one embodiment of a lease transaction system.

FIG. 24 is an example of a lease application interface for one embodiment of a lease transaction system.

FIG. 25 is an example of a lease application interface for one embodiment of a lease transaction system.

FIG. 26 is an example of a lease application interface for one embodiment of a lease transaction system.

FIG. 27 is an example of a lease application interface for one embodiment of a lease transaction system.

FIG. 28 is an example of a lease application interface for one embodiment of a lease transaction system.

FIG. 29 is an example of an Equipment Code Listing interface for one embodiment of a lease transaction system.

FIG. 30 is an example of a legal terms and conditions interface for one embodiment of a lease transaction system.

FIG. 31 is an example of a legal terms and conditions interface for one embodiment of a lease transaction system.

FIG. 32 is an example of a preview application interface for one embodiment of a lease transaction system.

FIG. 33 is an example of a preview application interface for one embodiment of a lease transaction system.

FIG. 34 is an example of a preview application interface for one embodiment of a lease transaction system.

FIG. 35 is an example of a payment estimator option interface for one embodiment of a lease transaction system.

FIG. 36 is an example of a payment estimate interface for one embodiment of a lease transaction system.

FIG. 37 is an example of a quote generator option interface for one embodiment of a lease transaction system.

FIG. 38 is an example of a generated quote.

FIG. 39 is an example of a view saved quotes interface for one embodiment of a lease transaction system.

FIG. 40 is an example of a transaction status option interface for one embodiment of a lease transaction system.

FIG. 41 is an example of a transaction status interface for one embodiment of a lease transaction system.

FIG. 42 is an example of a vendor lease application interface for one embodiment of a lease transaction system.

FIG. 43 is an example of a vendor lease application interface for one embodiment of a lease transaction system.

FIG. 44 is an example of a vendor lease application interface for one embodiment of a lease transaction system.

FIG. 45 is an example of an electronic mail notification to a customer that a vendor has submitted a partially completed lease application to a server system.

FIG. 46 is an example of a partially completed lease application interface for one embodiment of a lease transaction system.

FIG. 47 is an example of a partially completed lease application interface for one embodiment of a lease transaction system.

FIG. 48 is an example of a partially completed lease application interface for one embodiment of a lease transaction system.

FIG. 49 is an example of a partially completed lease application interface for one embodiment of a lease transaction system.

FIG. 50 is an example of an electronic mail notification to a vendor informing the vendor that the customer has submitted a fully completed application to a server system.

FIG. 51 is an example of a user account modification or set-up interface for one embodiment of a lease transaction system.

FIG. 52 is an example of a user update profile interface for one embodiment of a lease transaction system.

FIG. 53 is an example of an add a user to an office interface for one embodiment of a lease transaction system.

FIG. 54 is an example of an activate/deactivate user interface for one embodiment of a lease transaction system.

FIG. 55 is an example of a modify a user interface for one embodiment of a lease transaction system.

FIG. 56 is an example of an office selection interface for one embodiment of a lease transaction system.

FIG. 57 is an example of a Benefits of leasing interface for one embodiment of a lease transaction system.

FIG. 58 is an example of an Our leases interface for one embodiment of a lease transaction system.

FIG. 59 is an example of an Our leases interface for one embodiment of a lease transaction system.

FIG. 60 is an example of a Who we are interface for one embodiment of a lease transaction system.

FIG. 61 is an example of a Contact us interface for one embodiment of a lease transaction system.

FIG. 62 is an example of a Feedback interface for one embodiment of a lease transaction system.

FIG. 63 is an example of a Leasing FAQ interface for one embodiment of a lease transaction system.

FIG. 64 is an example of a Leasing FAQ interface for one embodiment of a lease transaction system.

FIG. 65 is an example of a CNA login interface for one embodiment of a lease transaction system.

FIG. 66 is an example of a CNA pre-approval interface for one embodiment of a lease transaction system.

FIG. 67 is an example of a CNA pre-approval expiration interface for one embodiment of a lease transaction system.

FIG. 68 is an example of a pre-approval activation interface for one embodiment of a lease transaction system.

FIG. 69 is an example of a pre-approval activation interface for one embodiment of a lease transaction system.

FIG. 70 is an example of a pre-approval activation interface for one embodiment of a lease transaction system.

FIG. 71 is an example of a pre-approval activation interface for one embodiment of a lease transaction system.

### DETAILED DESCRIPTION OF THE INVENTION

Set forth below are descriptions of embodiments of methods and systems for network-based equipment lease processing and management. The methods and systems facilitate electronic submission of lease applications using a client system, automatic credit decisions and automatic information processing using a server, and management of user accounts and lease transactions using a client system.

The methods and systems are not limited to the specific embodiments described herein. In addition, components of each system and each method can be practiced independent and separate from other components and methods described herein. Each component and method can also be used in combination with other components and methods. The term user, as used herein, refers to any of lease customers, i.e. individuals or entities leasing equipment, equipment manufacturers, equipment vendors, equipment brokers, and lease brokers.

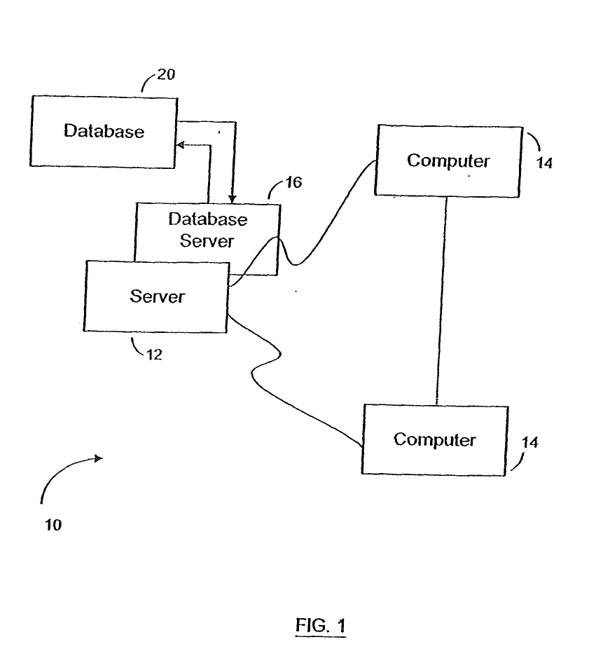

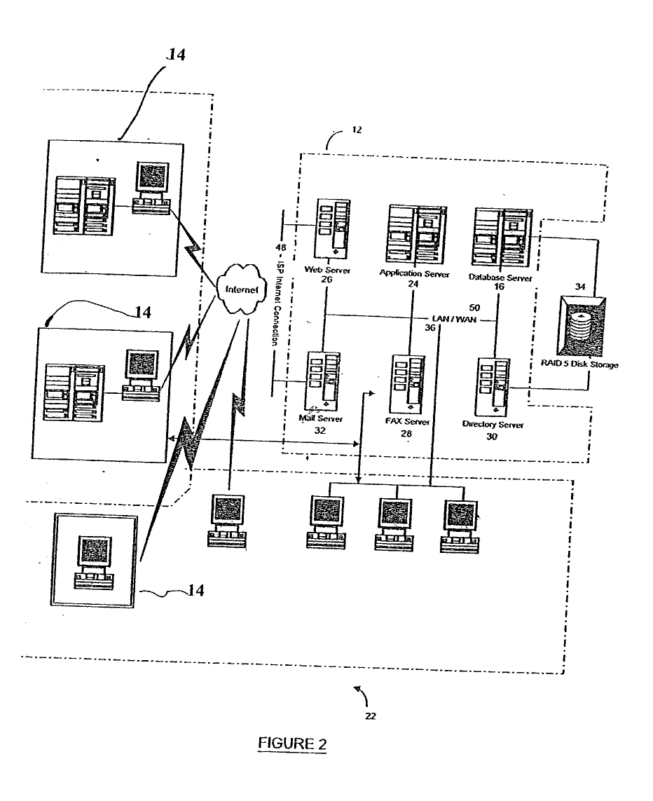

FIGS. 1 and 2 illustrate, in block diagram form, hardware architectures that can be utilized in connection with a lease transaction system. The system can be implemented on many different platforms and utilizing different architectures. The architectures illustrated in FIGS. 1 and 2, therefore, are examples only.

FIG. 1 is a simplified block diagram of a lease transaction system 10 for equipment lease management and processing. System 10 includes a server system 12 and a plurality of client systems 14 connected to server system 12. Client systems 14 are configured to communicate electronically with server system 12. In one embodiment, client systems 14 are computers including a web browser, and server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet, including a web-based telephone or other web-based connectable equipment. A database server 16 is connected to a centralized database 20 that contains user names, user passwords, and user profiles. Users can access server system 12 at client system 14 by logging onto server system 12 through client system 14.

In one embodiment, server system 12 is coupled to client systems 14 via a WAN or LAN. A user may dial or directly log on to an Intranet or the Internet to gain access. Each client system 14 includes an interface for communicating with server system 12. The interface allows a user to input data and to receive data relating to the request. A computer-based tool for equipment lease management and processing, as described below in more detail, is stored in server system 12 and can be accessed by a user at server system 12 or any of client systems 14.

Server system 12 is configured to electronically receive lease applications, electronically process lease applications, and electronically notify an applicant the status of the lease application, including whether the application was approved, denied or is on hold. The interface allows a user or applicant to input the lease application data and view a notification of the status of the application. Server system 12 is further configured to provide electronic management of lease transactions and user accounts, including user names, user passwords, and user profiles. The interface allows a user to view, and in some cases modify, data relating to lease transactions and user accounts. In one embodiment, the user or applicant is an equipment manufacturer, an equipment vendor, an equipment broker, a lease broker, or a lease customer.

FIG. 2 is an expanded version block diagram of one embodiment of server architecture of a lease transaction system 22. Components in system 22 identical to components of system 10 (shown in FIG. 1) are identified in FIG. 2 using the same reference numerals as used in FIG. 1. System 22 includes a server system 12 and a plurality of client systems 14. Server system 12 includes a database server 16 and further includes an application server 24, a web server 26, a fax server 28, a directory server 30, and a mail server 32. A disk storage unit 34 incorporating a computer-readable medium is coupled to database server 16 and directory server 30. Servers 16, 24, 26, 28, 30, and 32 are coupled in a local area network (LAN) 36.

As discussed above, server system 12 is configured to communicate with client systems 14. In one embodiment, communication is performed via the Internet, however, any other wide area network (WAN) type communication can be utilized in other embodiments, i.e., the methods and systems are not limited to being practiced via the Internet. In addition, and rather than a WAN, a local area network could be used in place of the WAN.

Database 20 (shown in FIG. 1), and within database server 16, contains stored user names, user passwords, and user profiles. The stored user names, passwords, and profiles may include, but are not limited to: vendor names, passwords, and profiles; equipment manufacturer names, passwords, and profiles; equipment broker names, passwords, and profiles; lease broker names, passwords, and profiles; and lease customer names, passwords, and profiles. The stored user names, passwords, and profiles correspond to users who have registered with lease transaction system 22. A user who has registered with lease transaction system 22 is assigned a user name and a user password.

As used herein, the term “user” may include, but is not limited to, vendor(s), equipment manufacturer(s), equipment broker(s), lease broker(s), and lease customer(s).

In one embodiment, a user must enter a valid user name and valid user password to access lease transaction system 22. In another embodiment, a user must enter a valid user name, a valid user password, and a valid user electronic mail address to access lease transaction system 22. The user name and user password correspond to a user profile stored in database 20. User profiles contain information about the user, such as the user's name, company name, address, phone number, and email address. In one embodiment, a user may be an entity, such as a corporation or a partnership. An entity user may include multiple users registered with lease transaction system 22. Each user within the entity is assigned a separate user name, password, and profile. In one embodiment, server system 12 is configured to automatically pre-approve registered users for equipment leases, and display such pre-approval on client system 14.

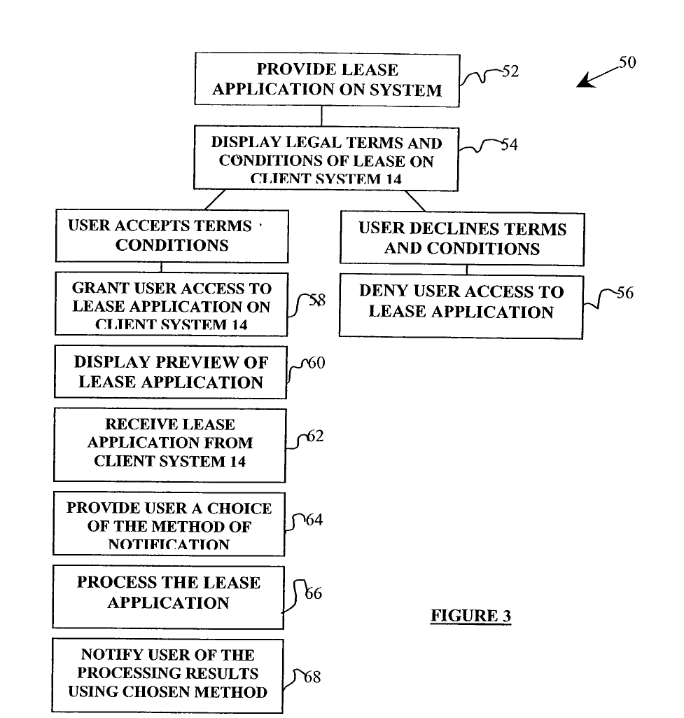

FIG. 3 illustrates one embodiment of a method 50 for equipment lease processing and management using lease transaction system 22. The method includes providing 52 a lease application within lease transaction system 22, wherein the lease application is accessible from client system 14 and can be completed using client system 14. In one embodiment, a user does not log in to lease transaction system 22 to access and complete the lease application. Also, in one embodiment, server system 12 displays 54 the legal terms and conditions for the lease application directly on client system 14. The user accepts the legal terms and conditions through an ‘accept’ link on client system 14. A user declines the legal terms and conditions through a ‘decline’ link on client system 14. If a user declines the legal terms and conditions, server system 12 denies 56 the user access to the lease application on client system 14. If a user accepts the legal terms and conditions, server system 12 grants 58 the user access to the lease application on client system 14.

A user granted access to the lease application completes the application directly from client system 14, and submits the application to server system 12 using client system 14. Server system 12 receives the lease application and displays 60 a preview of the lease application on client system 14. The user reviews the preview of the lease application on client system 14 and verifies that all information contained in the lease application is correct. If the lease application is correct the user electronically submits the lease application to server system 12 through a link on client system 14. Server system 12 receives 62 the lease application from client system 14 and electronically, and thus automatically, processes 64 the completed lease application. By processing the completed application, server system 12 determines whether to approve the lease, reject the lease, require that the user supply additional information, conditionally approve the lease, or hold the lease for further review.

Server system 12 provides 64 the user a choice of the method of notification. Once server system 12 has electronically processed 64 the completed lease application, server system 12 notifies 68 the user of the processing results, using the user's chosen method, thereby notifying the user of the status of the completed lease application. In one embodiment, server system 12 notifies the user by directly displaying the processing results on client system 14. In another embodiment, server system 12 notifies the user via electronic mail. In yet another embodiment, server system 12 notifies the user via facsimile.

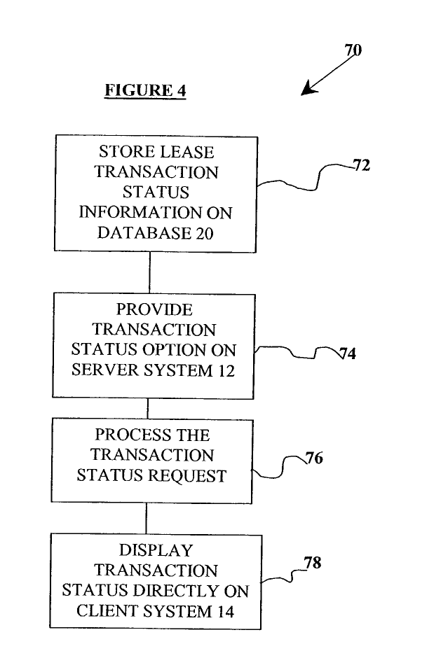

FIG. 4 illustrates one embodiment of a method 70 for equipment lease processing and management using lease transaction system 22. Method 70 includes storing 72 lease transaction status information on database 20, and providing 74, using server system 12, a transaction status option wherein a user requests the status of a submitted lease application using client system 14. Server system 12 processes 76 the transaction status request and displays 78 the status of the submitted lease application directly on client system 14. A user accesses, and thus initiates, the transaction status option directly from client system 14. Lease transaction status information may indicate that a lease has been appealed, approved, or rejected. In addition, lease transaction status information may indicate that a lease application includes errors, has been funded, or is still undergoing processing and review. The above examples of lease transaction status information are exemplary, and are not meant to be inclusive. In one embodiment, different users have different levels of access to the transaction status option, wherein the level of access a user has depends on the user's profile. For example, in one embodiment, a user's profile prevents a user from accessing the transaction status option.

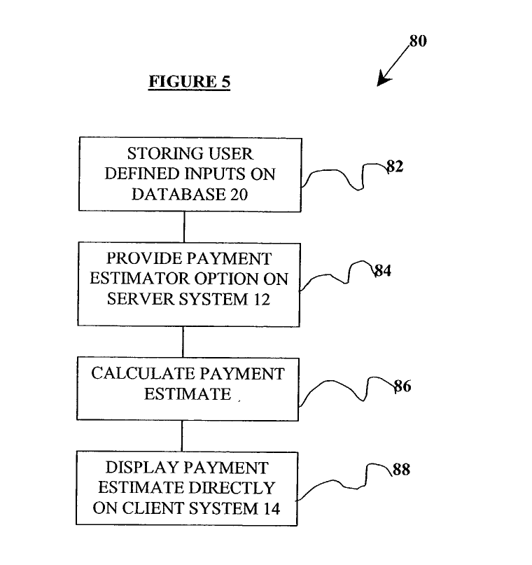

FIG. 5 illustrates one embodiment of a method 80 for equipment lease processing and management using lease transaction system 22. Method 80 includes storing 82 variables, hereinafter referred to as user-defined inputs, on database 20. The user-defined inputs include, but are not limited to, equipment types, equipment descriptions, and equipment costs. Server system 12 provides 84 a payment estimator option that determines a payment estimate for a lease. A user accesses the payment estimate option, and thus requests a payment estimate, directly from client system 14. Client system 14 and server system 12 are configured such that a user can input directly into client system 14 for delivery to server system 12. In one embodiment, user-defined inputs may include custom user-defined inputs corresponding to a particular vendor, manufacturer or broker. Server system 12 calculates 86 the lease payment estimate using lease rate information and the user-defined inputs. In one embodiment, lease rate information includes standard lease rates, sorted by equipment type, cost or code, and stored in database 20. In another embodiment, lease rate information includes custom lease rates corresponding to a particular vendor, manufacturer or broker. Server system 12 displays 88 the payment estimate directly on client system 14. Server system 12 is further configured such that the user prints the payment estimate directly from client system 14.

In one embodiment, server system 12 calculates the payment estimate by multiplying a Least Rate Factor (LRF) by the Equipment Costs, wherein:

$$LRF = \frac{[ ( PV - FV ) * ( SPPV ( I \% YR \div PPY : N ) ) - ( \$SD - ( \$SD * ( SPPV ( I \% YR \div PPY : N ) ) ) ) ]}{[ ( USPV ( I \% YR \div PPY : N ) - \# ADV ) + \# ADV - ( - \# SC + ( \# SD * ( SPPV ( I \% YR \div PPY : N ) ) ) ) ]}$$

and where:

PV=Present value

FV=Future value

SPPV=Single Payment Present Value;

1%YR=Annual Interest rate card per the base rate card+Discounts;

PPY=Payments per year;

N=Lease Term;

$SD=Used for a $ Amount of a Security Deposit;

#ADV=Number of Advance Payments;

#SD=Number of Security Deposits equal to the payment amount;

N=Term; and

USPV=Uniform Series Present Value.

Further, in another embodiment, users enter a valid user name and a valid user password to access the payment estimator option through client system 14. In an alternative embodiment, wherein a particular vendor's network includes a link to server system 12, and thus lease transaction system 22, and wherein a user accesses server system 12 via the link, server system 12 provides only custom lease rate information and custom user-defined inputs that correspond to the particular vendor.

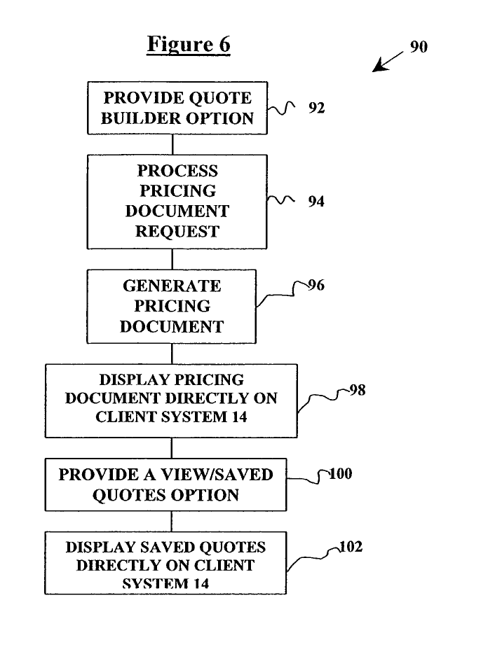

FIG. 6 illustrates one embodiment of a method 90 for equipment lease processing and management using lease transaction system 22. Method 90 includes providing 92, using server system 12, a quote builder option that generates a pricing document for a lease. A user accesses the quote builder option, and thus requests a pricing document, directly from client system 14. However, a user must enter a valid user name and valid user password to access the quote builder option. Server system 12 processes 94 the pricing document request, generates 96 a pricing document, and displays 98 the pricing document directly on client system 14. The pricing document indicates pricing information for a lease, for example, a pricing document may include the customer name, the lessor name, the equipment vendor name, equipment descriptions, equipment prices, the quote date, the quote expiration date, and pricing parameters. Server system 12 is configured to print the pricing document directly from client system 14. In one embodiment, server system 12 includes a link within the payment estimator option that links client system 14 to the quote builder option. In one embodiment, method 90 further includes providing 100, using server system 12, a view saved quotes option within the quote builder option, wherein a user views on client system 14 a user's pricing documents that are stored in database 20. Method 90 further includes displaying 102 saved quotes on client system 14. A user views stored pricing documents on client system 14 and prints stored pricing documents directly from client system 14.

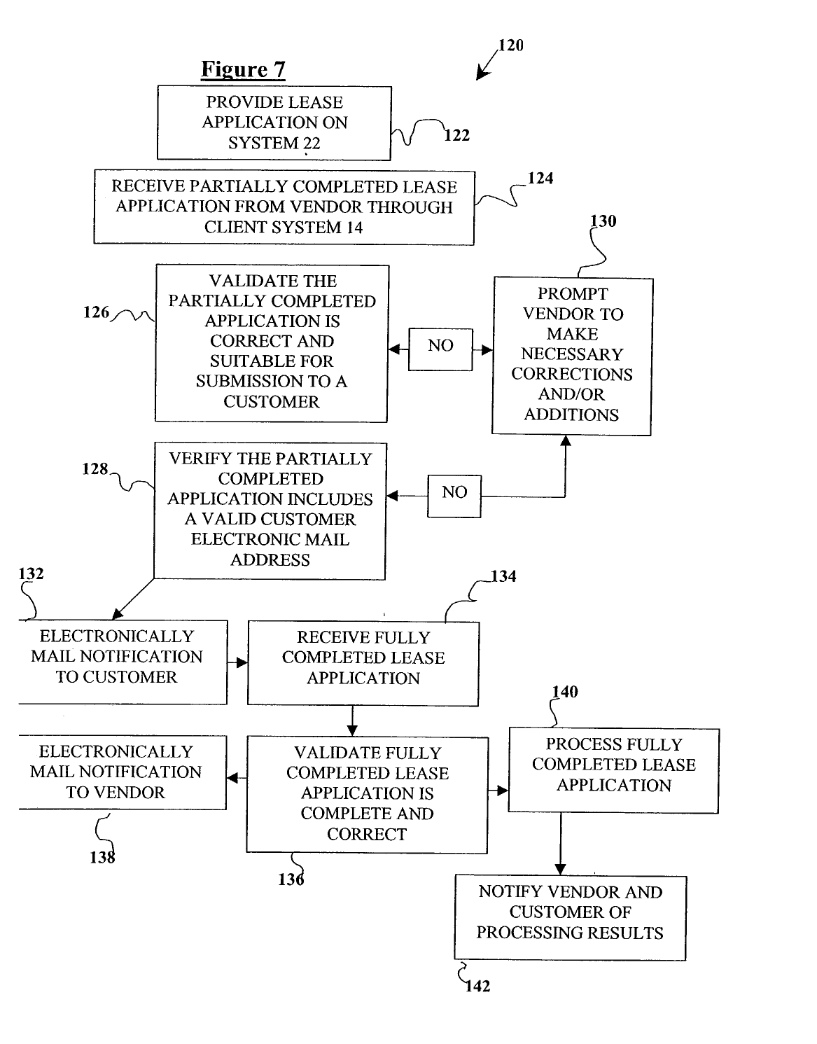

FIG. 7 illustrates one embodiment of a method 120 for equipment lease processing and management using lease transaction system 22. Server system 12 provides 122 a lease application on lease transaction system 22. A vendor accesses the lease application from client system 14 and partially completes the lease application on client system 14. It will be understood that the term ‘vendors’ or ‘vendor’ includes brokers and equipment manufacturers. For example, in one embodiment, a vendor is an equipment broker. In one embodiment, a vendor does not log in to lease transaction system 22 to access to the lease application. In an alternative embodiment, a vendor enters a valid vendor name and a valid vendor password to access the lease application. A vendor electronically submits the partially completed application to server system 12, using client system 14. Alternatively, and in one embodiment, a vendor prints the partially completed application and manually mails the partially completed lease application to a customer. Furthermore, in one embodiment, a vendor submits a fully completed application to server system 12, using client system 14.

Server system 12 receives 124 the partially completed application and validates 126 that the partially completed lease application is correct, free from errors and in proper form for submission to a customer. Server system 12 also verifies 128 that the partially completed application includes a valid customer electronic mail address. If server system 12 determines that the partially completed lease application does not contain a valid customer electronic mail address, is not correct, or is not in the proper form, server system 12 prompts 130 the vendor to make any necessary corrections or additions to the partially completed lease application using client system 14. Server system 12 further electronically mails 132 notification to a customer that a vendor has submitted a partially completed lease application to server system 12. The electronic mail notification includes a valid customer name, a valid customer password, and instructions for submitting a fully completed application to server system 12. The electronic mail notification further includes a link configured to access the partially completed lease application using a client system 14. A customer views, modifies, and fully completes the partially completed lease application using the client system 14. In one embodiment, the customer must use the valid customer name and valid customer password to access the partially completed lease application.

Client system 14 electronically sends the fully completed lease application to server system 12, which receives 134 the fully completed lease application. Server system 12 validates 136 the fully completed application is complete and correct. Once server system 12 receives 134 the filly completed application from the customer, server system 12 electronically mails 138 notification to the vendor informing the vendor that the customer has submitted a fully completed application to server system 12. In one embodiment, the electronic mail notification to the vendor includes the customer's business name, the customer contact name, and the date the fully completed application was submitted to server system 12.

Server system 12 electronically, and thus automatically, processes 140 the fully completed lease application. By processing the completed application, server system 12 determines whether to approve the lease, reject the lease, require that the user supply additional information, conditionally approve the lease, or hold the lease for further review. In one embodiment, server system 12 displays (not shown) a preview of the partially completed lease application on client system 14. In addition, and in another embodiment, server system 12 displays (not shown) a preview of the fully completed lease application on client system 14.

Once server system 12 has processed 140 the fully completed lease application, server system 12 notifies 142 the vendor and the customer of the processing results, thereby notifying the vendor and customer the status of the completed lease application. In one embodiment, server system 12 notifies 142 the customer and/or vendor by directly displaying the processing results on client systems 14. In another embodiment, the vendor and/or customer choose a method of notification and server system 12 notifies 142 the vendor and/or customer using the chosen method of notification. For example, in one embodiment, the vendor chooses to be notified of the processing results via electronic mail and server system 12 notifies 142 the vendor via electronic mail.

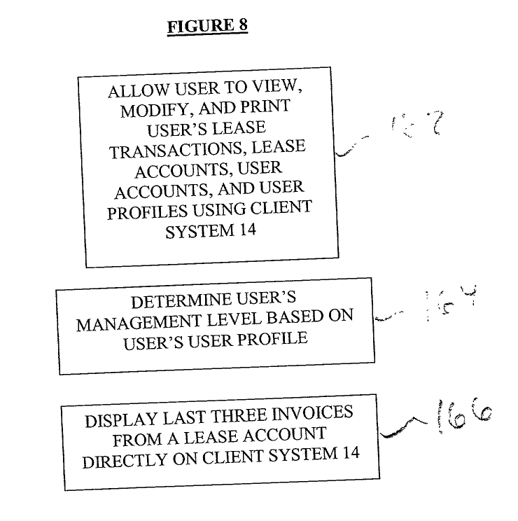

FIG. 8 illustrates one embodiment of a method 160 for allowing a user to manage the user's lease transactions, lease accounts, user accounts, and user profile. More particularly, server system 12 allows 162 a user to view, modify, and print the user's lease transactions, lease accounts, user accounts, and user profiles using client system 14. In one embodiment, server system 12 determines 164 a user's management level from the user's user profile, wherein the user's management level determines the amount and extent of access the user is given to view, modify, and print the user's lease transactions, lease accounts, user accounts, and user profile. Further, and in one embodiment, server system 12 displays 166 the last three invoices of a lease account directly on client system 12. A user prints the last three invoices of a lease account directly from client system 12.

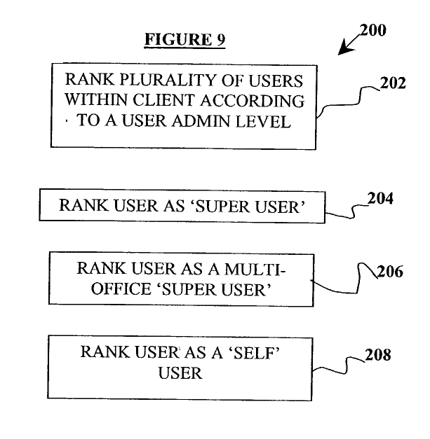

FIG. 9 illustrates one embodiment of a method 200 for client lease management. In one embodiment, lease transaction system 22 includes clients that have a plurality of users. In addition, and in another embodiment, clients have multiple offices, each office including a plurality of users. Server system 12 ranks 202 the plurality of users within the client according to a User Admin Level. The User Admin Level (UAL) determines a user management level for management of lease transactions, lease accounts, other user accounts, and other user profiles. The UAL determines the amount and extent of access a user is given to view, modify, and print lease transactions, lease accounts, other user accounts, and other user profiles. It will be understood that management of lease transactions and lease accounts may include viewing on client system 14, and printing directly from client system 14, the last three invoices for a lease account.

In one embodiment, server system 12 ranks 204 a user as a ‘super user’ UAL. A super user has a high user management level for management of lease transactions, lease accounts, user accounts, and user profiles for the client. For example, a super user adds users to the client, inactivates users from the client, and modifies users' UALs, accounts, and profiles. In one embodiment, a super user only manages lease transactions, lease accounts, user accounts, and user profiles within the super user's own office. Server system 12 also ranks 206 a user as a ‘multi-office super user’ UAL. A multi-office super user has full management of lease transactions, lease accounts, user accounts, and user profiles for the client. For example, a multi-office super user adds users to the client, inactivates users from the client, and modifies users' UALs, accounts, and profiles for all the client's offices. Furthermore, a multi-office super user adds users to an office, inactivates users from an office, activates an office, deactivates an office, and modifies an office. In another embodiment, server system 12 ranks 208 a user as a ‘self’ user UAL. A self-user has a very low management level for management of lease transactions, lease accounts, user accounts, and user profiles for the client. For example, a self-user only modifies the self user's lease transactions, lease accounts, user accounts, UAL, and user profile.

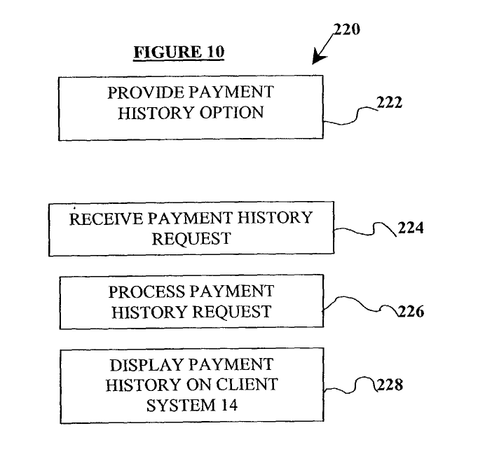

FIG. 10 illustrates one embodiment of a method 220 for equipment lease processing and management using lease transaction system 22. Method 220 includes providing 222, using server system 12, a payment history option. When a registered user who's user profile grants the user access to lease and user accounts requests a payment history, server system 12 receives 224 the payment history request, processes 226 the request, and displays 228 the payment history on client system 14. In one embodiment, brokers and vendors access the payment history of an “account”, regardless of whether the vendor or broker originated the lease. Further, and in one embodiment, payment histories are not available to lessees or third parties to the lease.

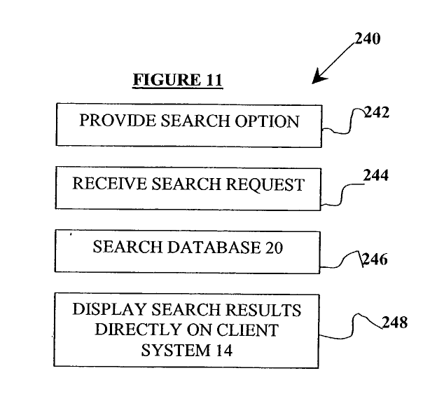

FIG. 11 illustrates one embodiment of a method 240 for equipment lease processing and management using lease transaction system 22. Server system 12 provides 242 a search option that searches database 20, using server system 12. When a user requests a search, server system 12 receives 244 the search request and searches 246 database 20. In one embodiment, server system 12 searches 246 for at least one of a business name, application number, transaction I.D., and status, depending on the search request. Server system 12 displays 248 the search results directly on client system 14.

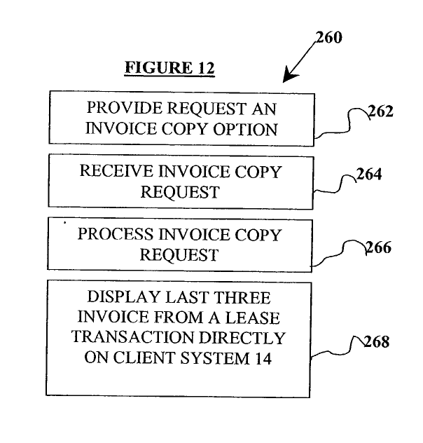

FIG. 12 illustrates one embodiment of a method 260 for equipment lease processing and management using lease transaction system 22. Server system 12 provides 262 a request an invoice copy option, wherein a user accesses the last three invoices from a lease transaction on client system 14. When server system 12 receives 264 an invoice copy request, server system 12 processes the request and displays the last three invoices from a lease transaction directly on client system 14. In one embodiment, a user prints the last three invoices from a lease transaction directly from client system 14.

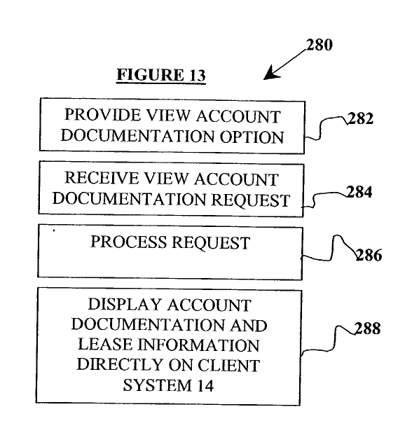

FIG. 13 illustrates one embodiment of a method 280 for equipment lease processing and management using lease transaction system 22. Server system 12 provides 282 a view account documentation option, wherein a user views account documentation and lease information on client system 14. When server system 12 receives 284 a view account documentation request, server system 12 processes 286 the request and displays 288 the account documentation and lease information directly on client system 14. In one embodiment, a user prints the account documentation and lease information directly from client system 14.

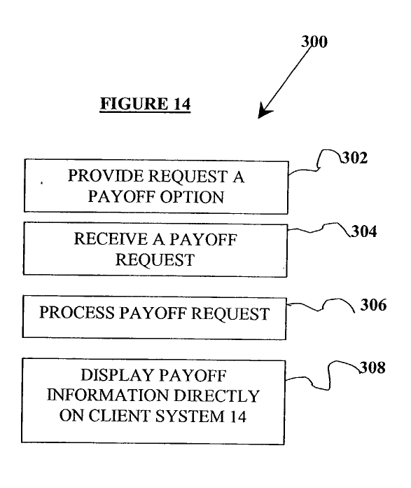

FIG. 14 illustrates one embodiment of a method 300 for equipment lease processing and management using lease transaction system 22. Server system 12 provides 302 a request a payoff option, wherein a user requests a current payoff on a lease account using client system 14. When server system 12 receives 304 a payoff request, server system 12 processes 306 the request and displays 308 the payoff information directly on client system 14. Payoff information may include, but is not limited to, amount of payoff and the expiration date of the payoff. In one embodiment, the type of lease account and the delinquency of the lease account determine whether payoff information is displayed on client system 14.

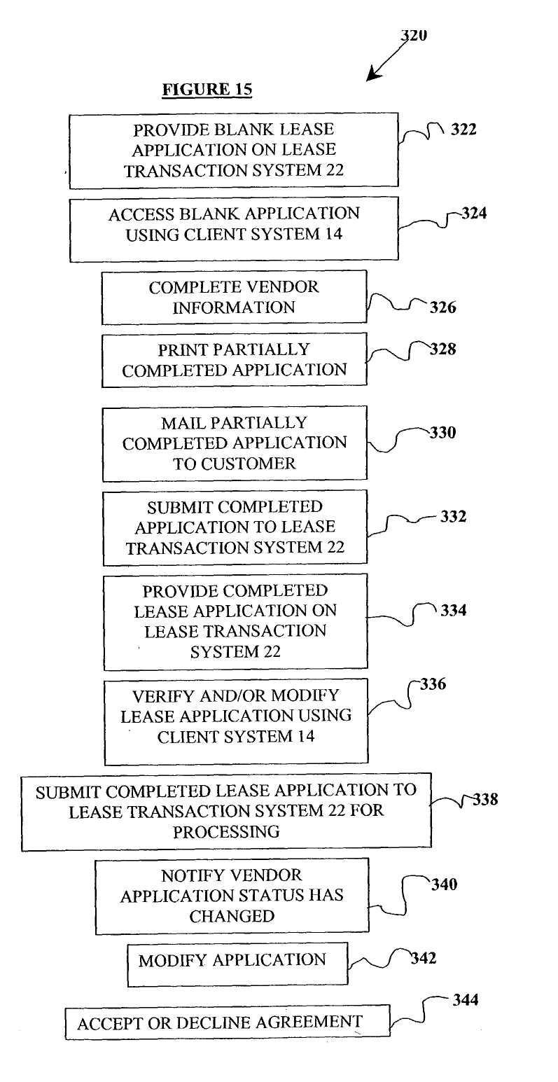

FIG. 15 illustrates one embodiment of method 320 for equipment lease processing and management using lease transaction system 22. Server system 12 provides 322 a blank lease application on lease transaction system 22. A vendor accesses 324 the blank application using client system 14. In one embodiment, the vendor completes 326 vendor information, prints 328 the partially completed application, and mails 330 the partially completed application to a customer for completion. In an alternative embodiment, the vendor faxes the partially completed application to a customer for completion. In another alternative embodiment, the vendor e-mails the partially completed lease application to a customer for completion. The customer submits 332 the completed application to lease transaction system 22. In one embodiment, the customer submits the completed lease application to lease transaction system 22 via facsimile. In an alternative embodiment, the customer submits the completed lease application via e-mail.

In one embodiment, the customer is a user and server system 12 provides 334 the completed lease application on lease transaction system 22 and the user, or customer, can verify and/or modify 336 the lease application on client system 14. The user then submits 338 the lease application to lease transaction system 22 for processing. Lease transaction system 22 then notifies 340 the vendor that the application status has changed. In one embodiment, lease transaction system 22 notifies the vendor via e-mail. In an alternative embodiment, lease transaction system 22 notifies the vendor via the transaction status option described above. In another embodiment, if the completed lease application is incorrect or incomplete, a user or vendor modifies 342 the application through the transaction status option described above. When the application is complete and correct, the user or customer accepts or declines the lease agreement using client system 14 and lease transaction system 22.

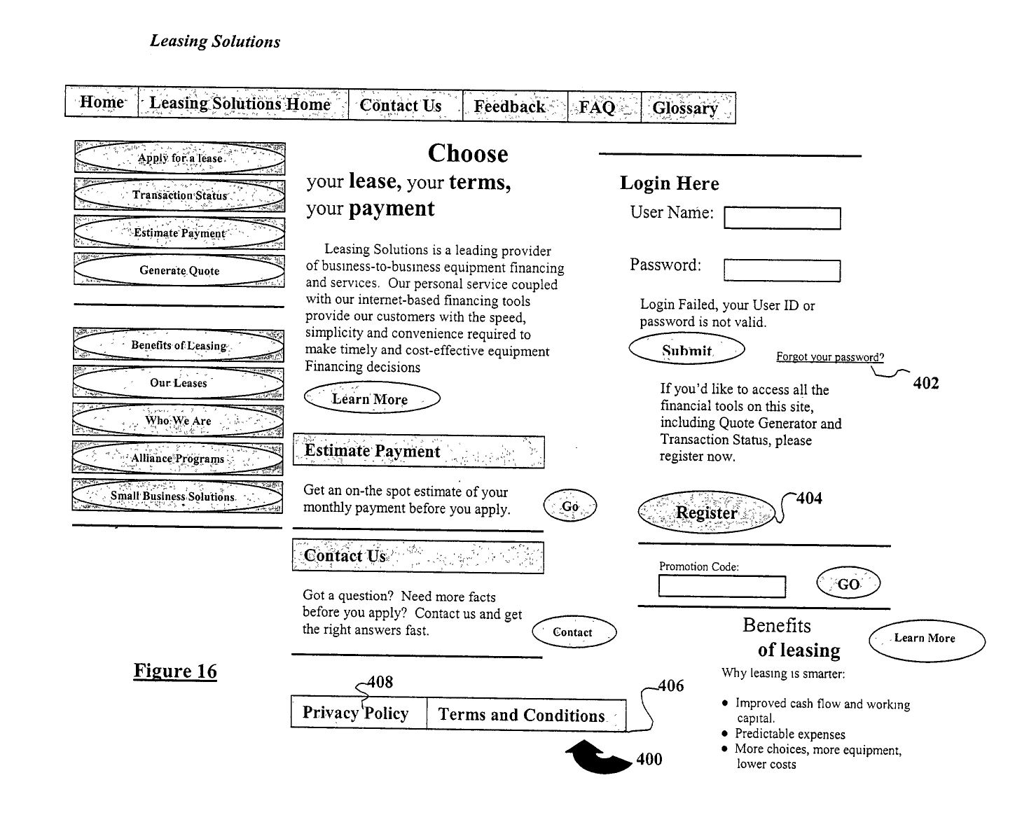

FIG. 16 is an example of a login user interface 400 for one embodiment of lease transaction system 22 (shown in FIG. 2). Registered users access lease transaction system 22 by entering a valid user name and password. If a password is forgotten, a link 402 exists where a user can change the user's password. Interface 400 also includes a registration link 404 where a non-registered user can register. In addition, a link 406 is provided to the terms and conditions of lease transaction system 22. Further, a link 408 is provided to the privacy policy of lease transaction system 22.

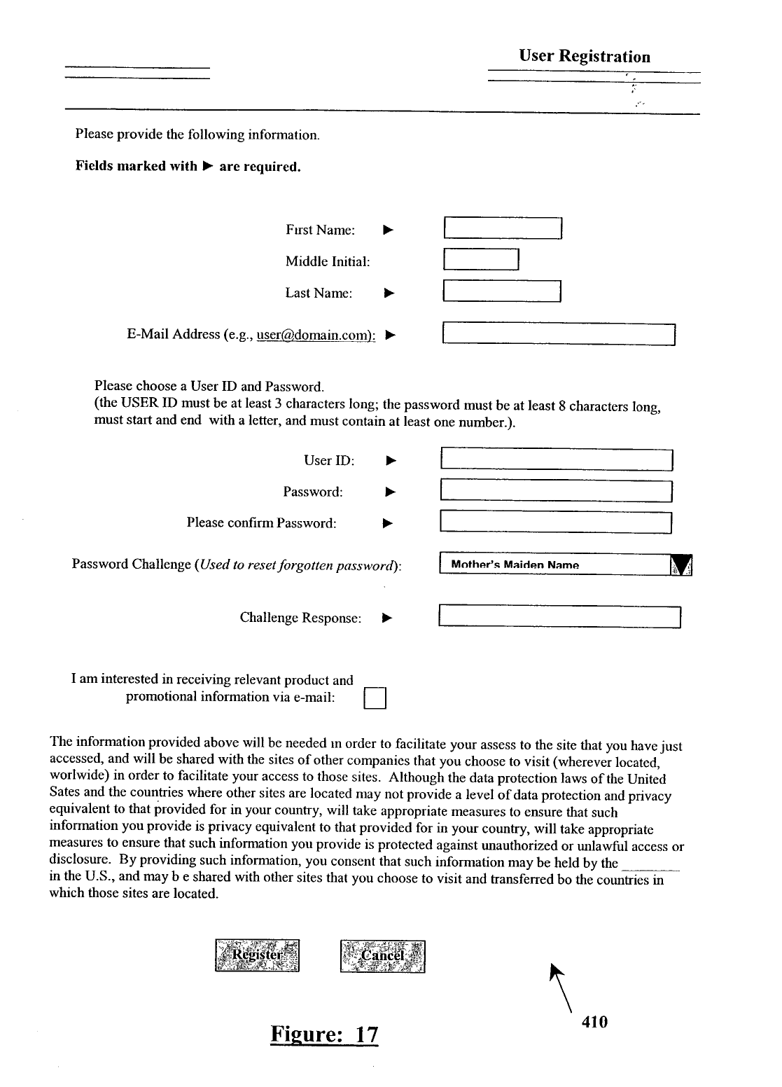

FIG. 17 is an example of a user registration interface 410 for lease transaction system 22 (shown in FIG. 2). A user accesses registration user interface 410 from link 404 (shown in FIG. 15) on login user interface 400 (shown in FIG. 15). A user enters the user's first name, middle initial, last name, and email address to register. In addition, the user chooses a user identification, also referred to herein as a user name, a user password, and a user password challenge. In one embodiment, a registering user also provides information regarding the user's entity.

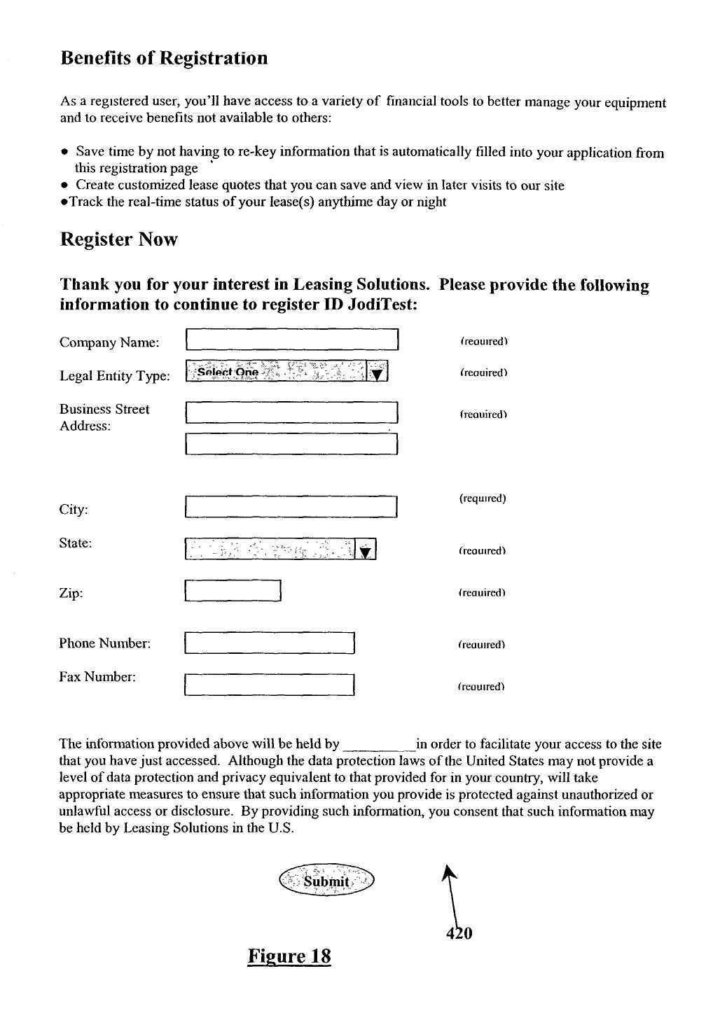

FIG. 18 is an example of a user registration interface 420 for lease transaction system 22 (shown in FIG. 2). User registration interface 420 accepts information regarding the user's entity to register. For example, user interface 420 accepts an entity name, the legal entity status of the entity, the business address of the entity, and the phone number and fax number of the entity.

Once a user has successfully completed user registration interface 410 (shown in FIG. 16) and user registration interface 420, lease transaction system 22 notifies the user of a successful registration.

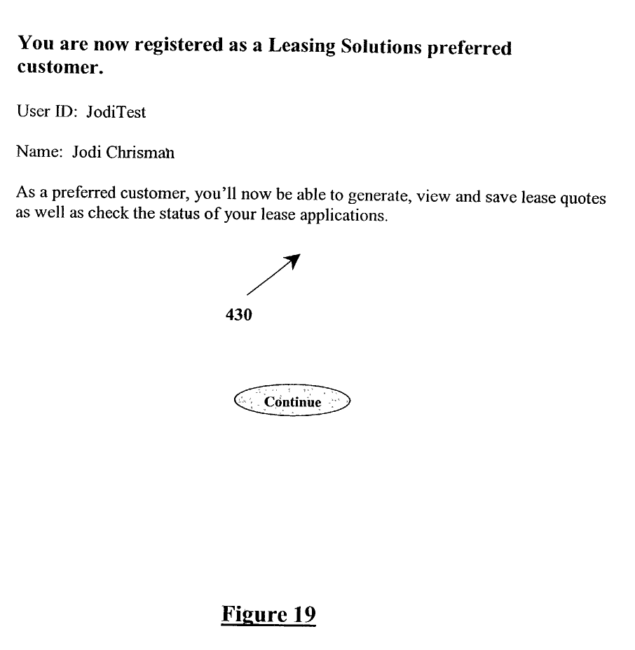

FIG. 19 is an example of a user registration notification interface 430 for lease transaction system 22 (shown in FIG. 2). User registration notification interface 430 includes the user's first and last name, and user name.

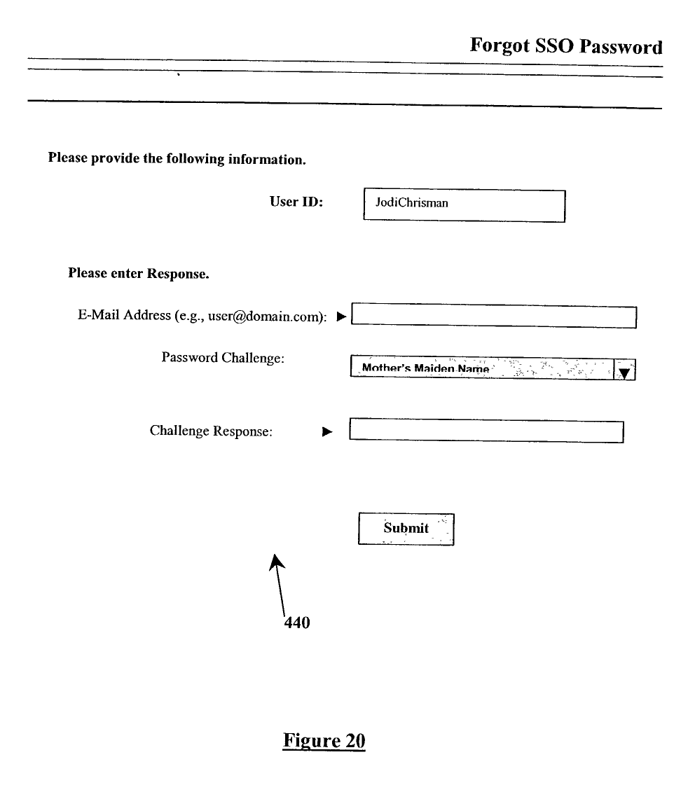

FIG. 20 is an example of a user forgot password interface 440 for lease transaction system 22 (shown in FIG. 2). A user gains access to interface 440 through link 402 (shown in FIG. 15) on login user interface 400 (shown in FIG. 15). A user enters selected information into interface 440. In the exemplary embodiment, such requested info includes a valid user name, a valid user email, and a valid user password challenge response. If the user successfully completes password interface 440, lease transaction system 22 automatically resets the user's password and displays a notification of the new password on the user's client system 14 (shown in FIG. 2).

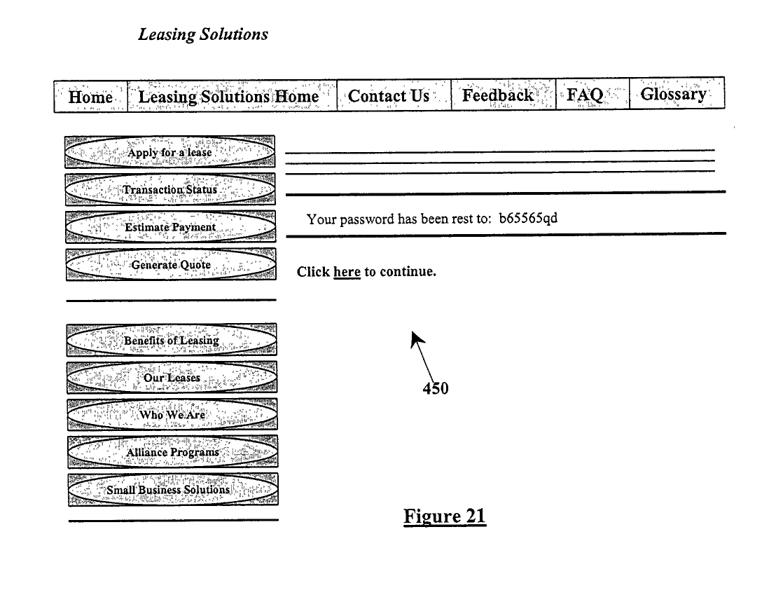

FIG. 21 is an example of a user new password interface 450 for lease transaction system 22 (shown in FIG. 2). User new password interface 450 displays a new user password.

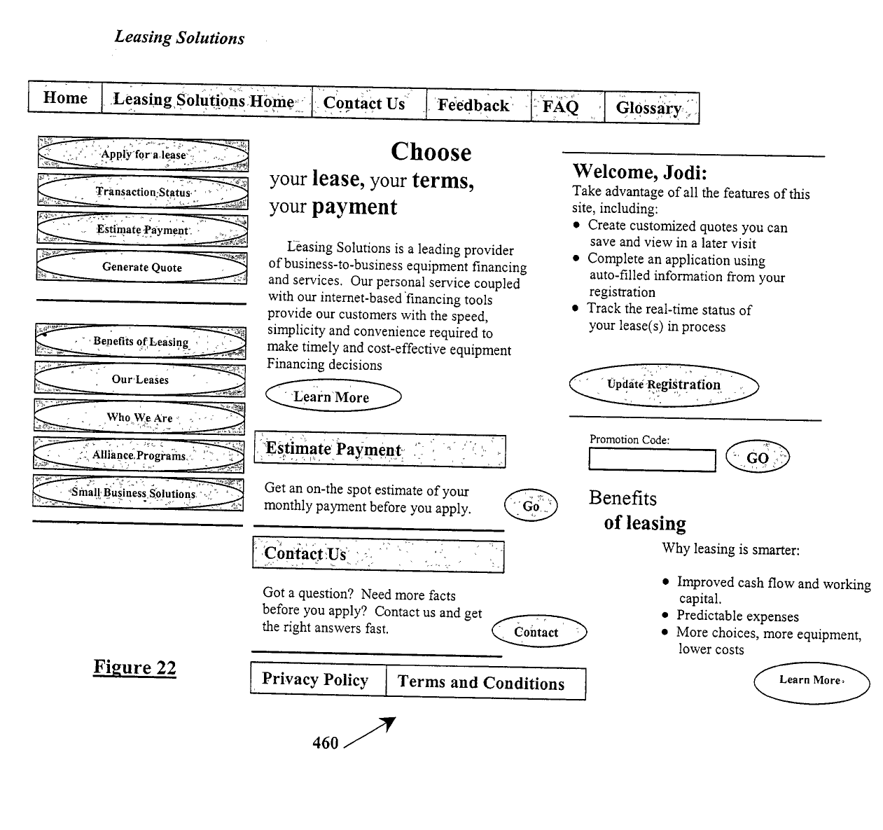

FIG. 22 is an example of a main customer interface 460 for lease transaction system 22 (shown in FIG. 2). Main customer interface 460 is accessible after a registered customer has successfully logged-in to lease transaction system 22 using login user interface 400 (shown in FIG. 15). Main customer interface 460 includes a personalized greeting 462.

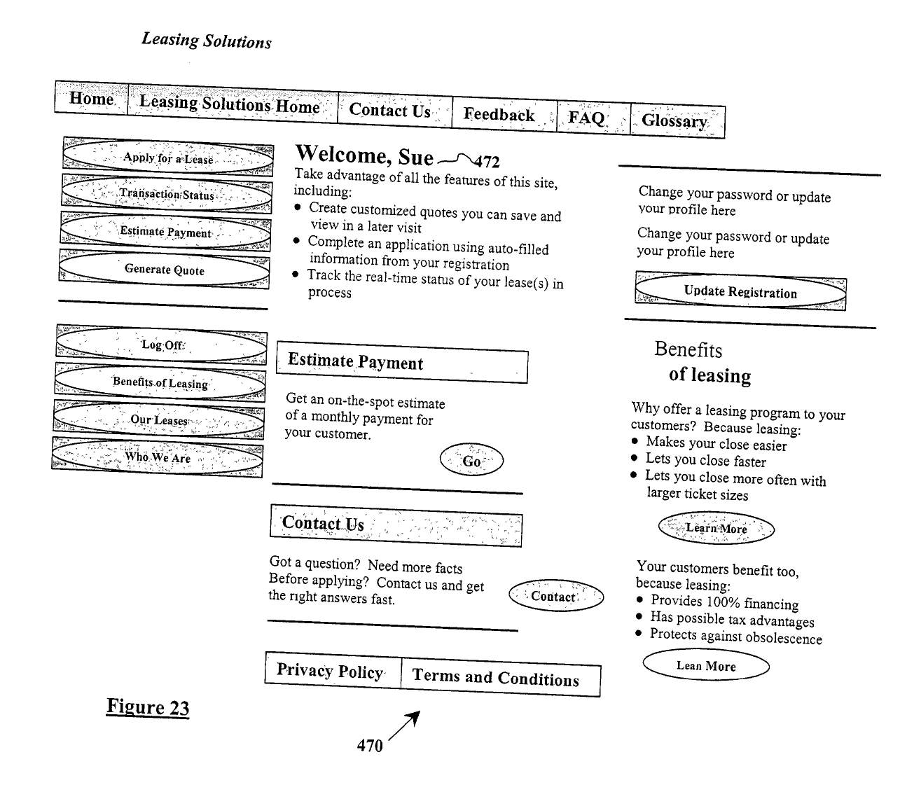

FIG. 23 is an example of a main vendor interface 470 for lease transaction system 22 (shown in FIG. 2). Main vendor interface 470 is accessible after a registered vendor has successfully logged-in to lease transaction system 22 using login user interface 400 (shown in FIG. 15). Main vendor interface 470 includes a personalized greeting 472. Although main vendor interface 470 is illustrated as applying to equipment vendors, it will be understood that main vendor interface 470 is also applicable to equipment manufacturers, equipment brokers, and lease brokers.

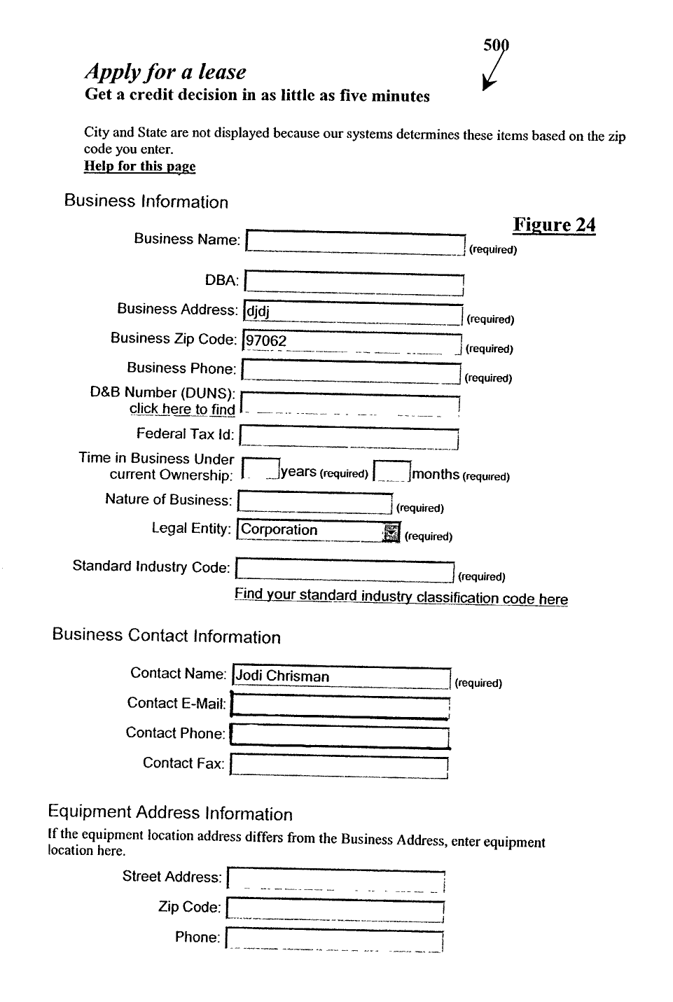

FIG. 24 is an example of a lease application interface 500 for lease transaction system 22 (shown in FIG. 2). Lease application interface 500 represents the first page of an on-line lease application and is accessible from client system 14. Lease application interface 500 includes inputs for Business Information, Business Contact Information, Equipment Address Information, and Personal Information.

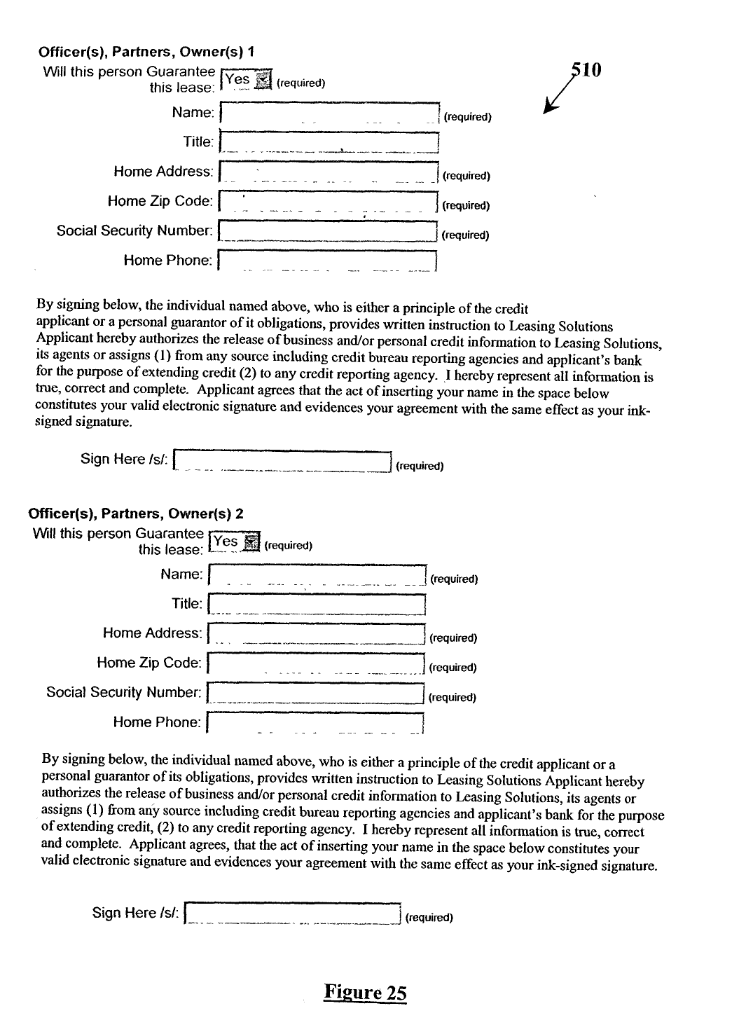

FIG. 25 is an example of a lease application interface 510 for lease transaction system 22 (shown in FIG. 2). Lease application interface 510 represents the second page of an on-line lease application and is accessible from client system 14. Lease application interface 510 includes inputs for Business Officer, Partner, and Owner information.

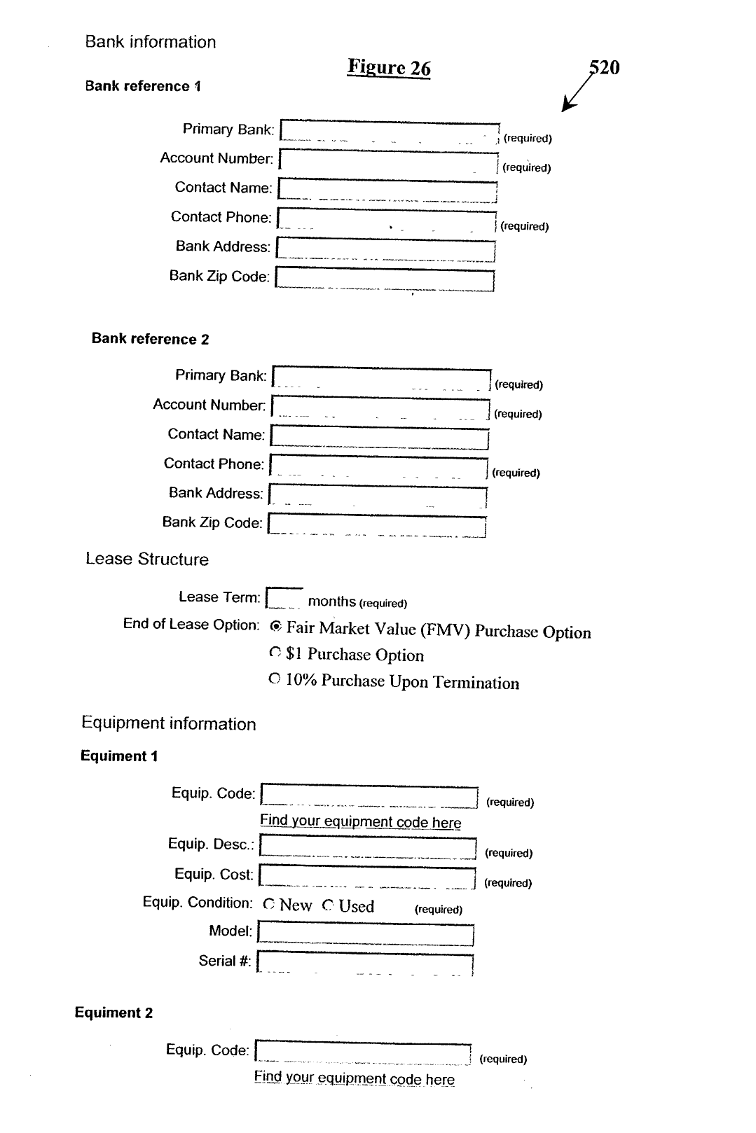

FIG. 26 is an example of a lease application interface 520 for lease transaction system 22 (shown in FIG. 2). Lease application interface 520 represents the third page of an on-line lease application and is accessible from client system 14. Lease application interface 520 includes inputs Bank references, the Lease Structure, and Equipment Information. The Equipment Information input includes inputs for an Equipment Code, an Equipment Description, an Equipment Cost, an Equipment Condition, an Equipment Model, and an Equipment Serial number.

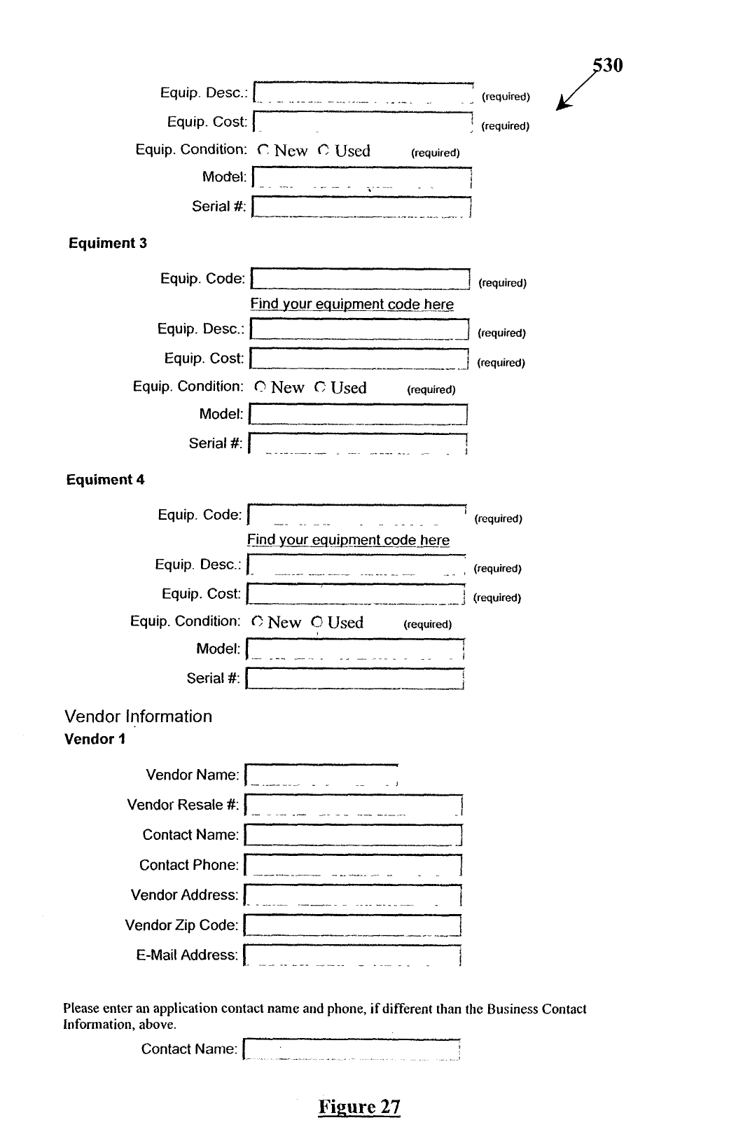

FIG. 27 is an example of a lease application interface 530 for lease transaction system 22 (shown in FIG. 2). Lease application interface 530 represents the fourth page of an on-line lease application and is accessible from client system 14. Lease application interface 530 includes inputs for Equipment Information, including inputs for Equipment Codes, Equipment Descriptions, Equipment Costs, Equipment Conditions, Equipment Models, and Equipment Serial numbers. Lease application interface 530 further including an input for Vendor Information, including a Vendor name, Resale number, Contact Name, Contact Phone, Vendor Address, Vendor Zip Code, and E-Mail Address.

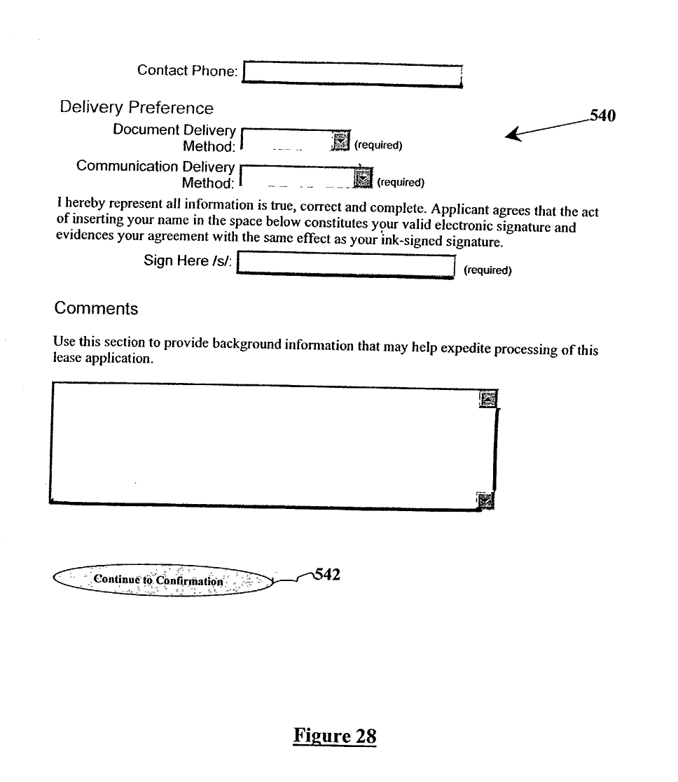

FIG. 28 is an example of a lease application interface 540 for lease transaction system 22 (shown in FIG. 2). Lease application interface 540 represents the final page of an on-line lease application and is accessible from client system 14. Lease application interface 540 includes inputs for Delivery Preference, an electronic signature, and Comments. Interface 540 includes a link 542 to continue confirmation of the lease application.

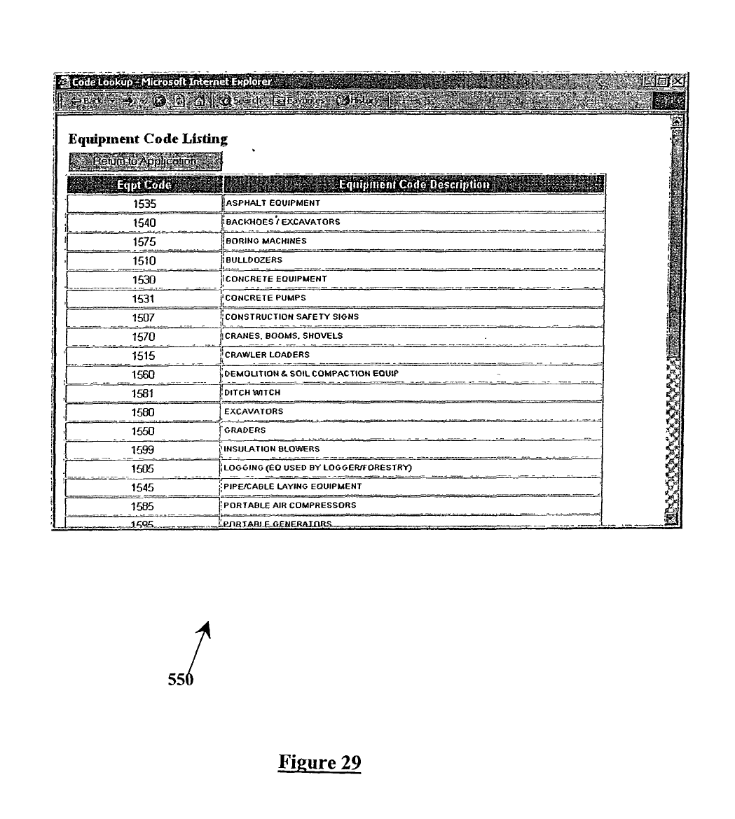

FIG. 29 is an example of an Equipment Code Listing interface 550 for lease transaction system 22 (shown in FIG. 2). Equipment Code Listing interface 550 displays codes for various types of equipment and is accessible from client system 14.

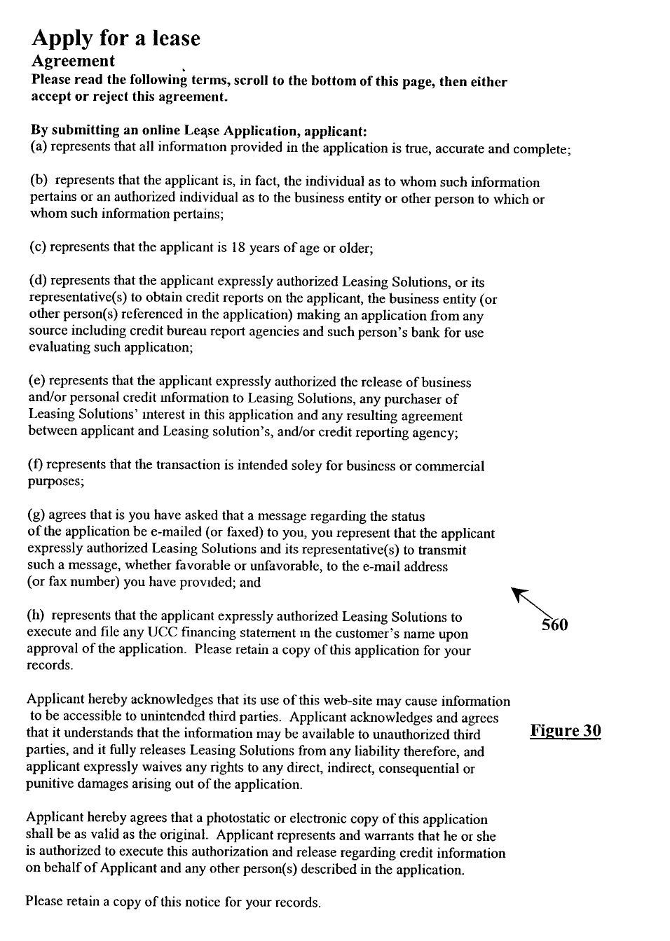

FIG. 30 is an example of a legal terms and conditions interface 560 for lease transaction system 22 (shown in FIG. 2). Interface 560 represents the first page of the legal terms and conditions for a lease application and is accessible from client system 14.

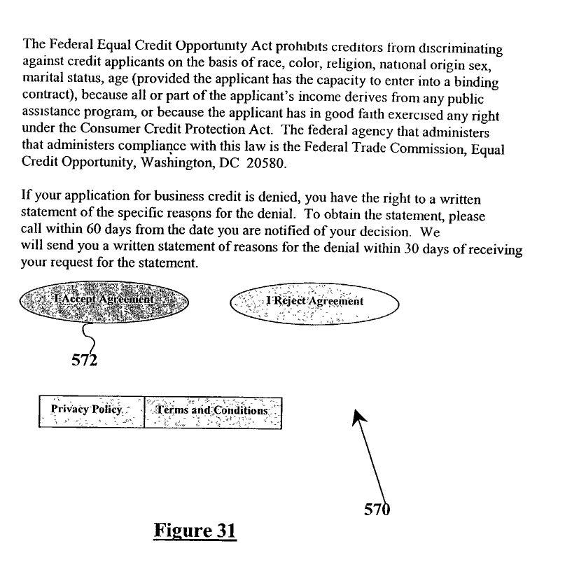

FIG. 31 is an example of a legal terms and conditions interface 570 for lease transaction system 22 (shown in FIG. 2). Interface 570 represents the second page of the legal terms and conditions for a lease application and is accessible from client system 14. Interface 570 includes a link 572 for accepting the legal terms and conditions.

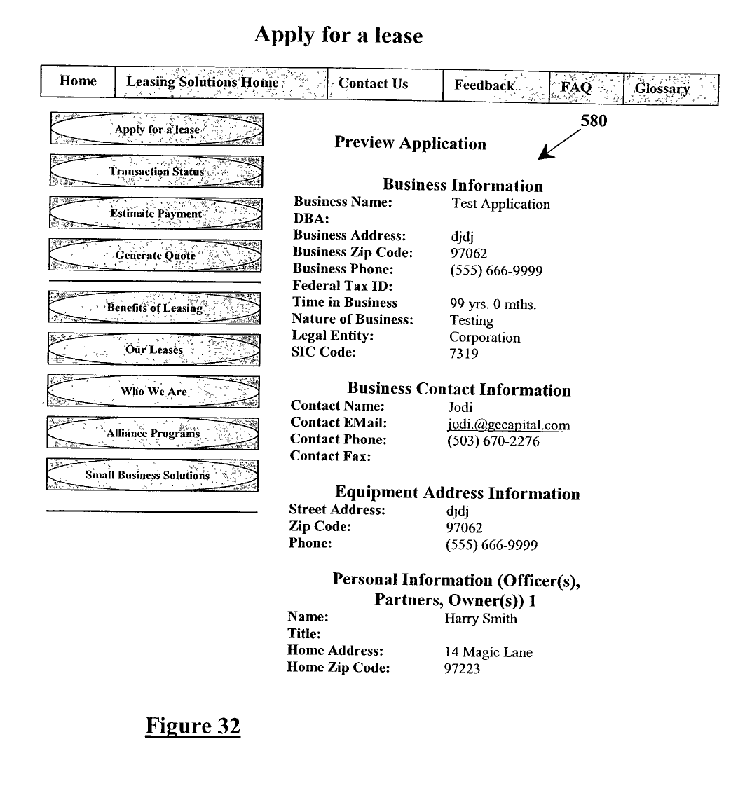

FIG. 32 is an example of a preview application interface 580 for lease transaction system 22 (shown in FIG. 2). Interface 580 represents the first page of a preview lease application and is accessible from client system 14. Interface 580 displays Business Information, Business Contact Information, Equipment Address Information, and Personal Information.

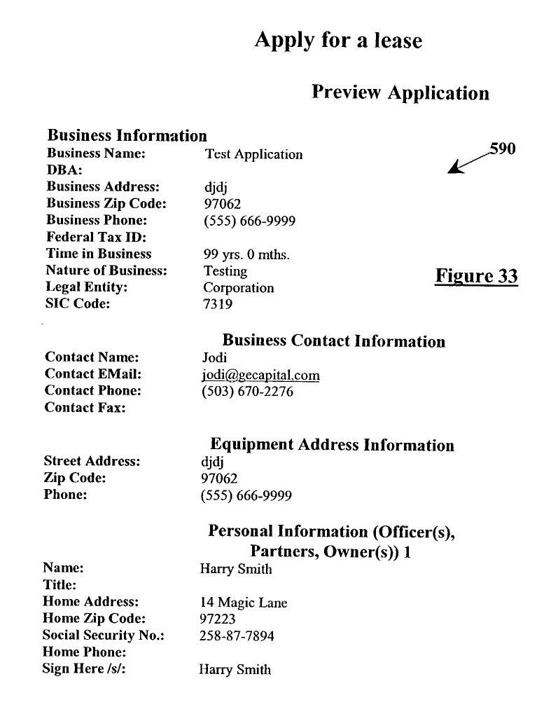

FIG. 33 is an example of a preview application interface 590 for lease transaction system 22 (shown in FIG. 2). Interface 590 represents the second page of a preview lease application and is accessible from client system 14. Interface 590 displays Business Information, Business Contact Information, Equipment Address Information, and Personal Information.

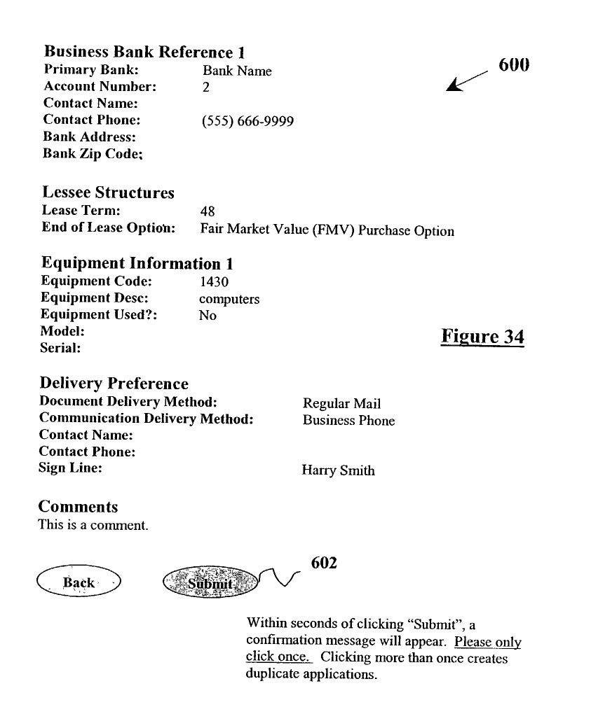

FIG. 34 is an example of a preview application interface 600 for lease transaction system 22 (shown in FIG. 2). Interface 600 represents the final page of a preview lease application and is accessible from client system 14. Interface 600 displays Business Bank Reference information, the Lessee Structures, Equipment Information, Delivery Preference, and Comments. Interface 600 includes a link 602 to submit the lease application to server system 12 (shown in FIG. 2).

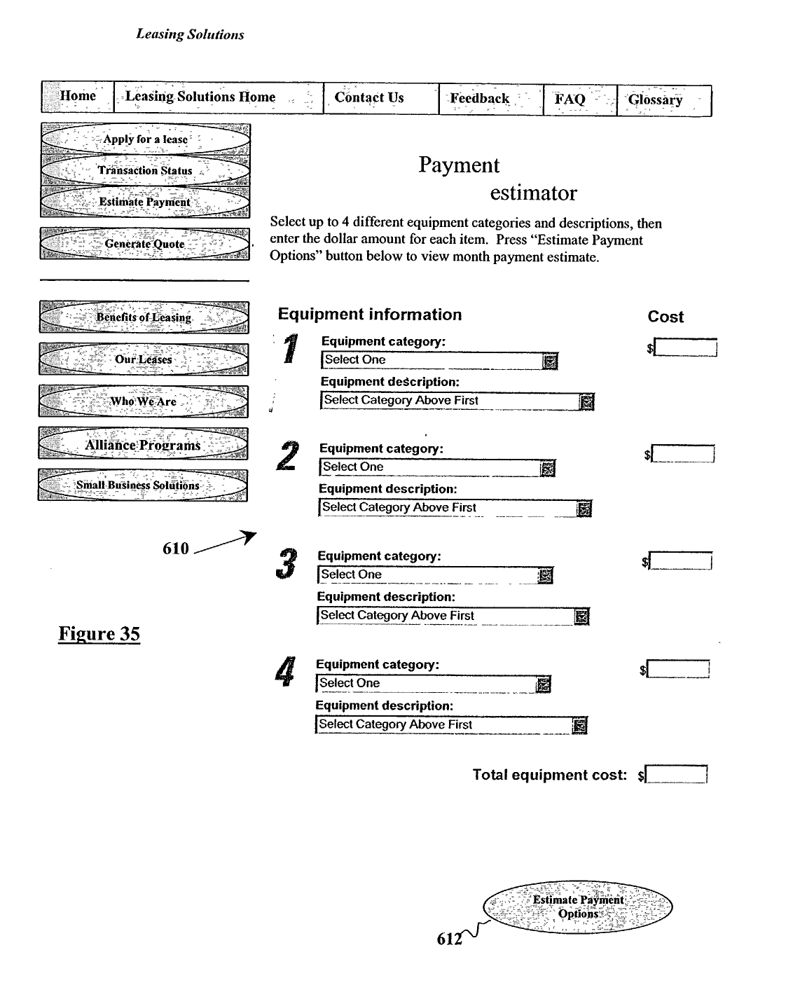

FIG. 35 is an example of a payment estimator option interface 610 for lease transaction system 22 (shown in FIG. 2). Interface 610 includes selection for equipment category, equipment description, and equipment cost. A link 612 is included that initiates generation of the payment estimate.

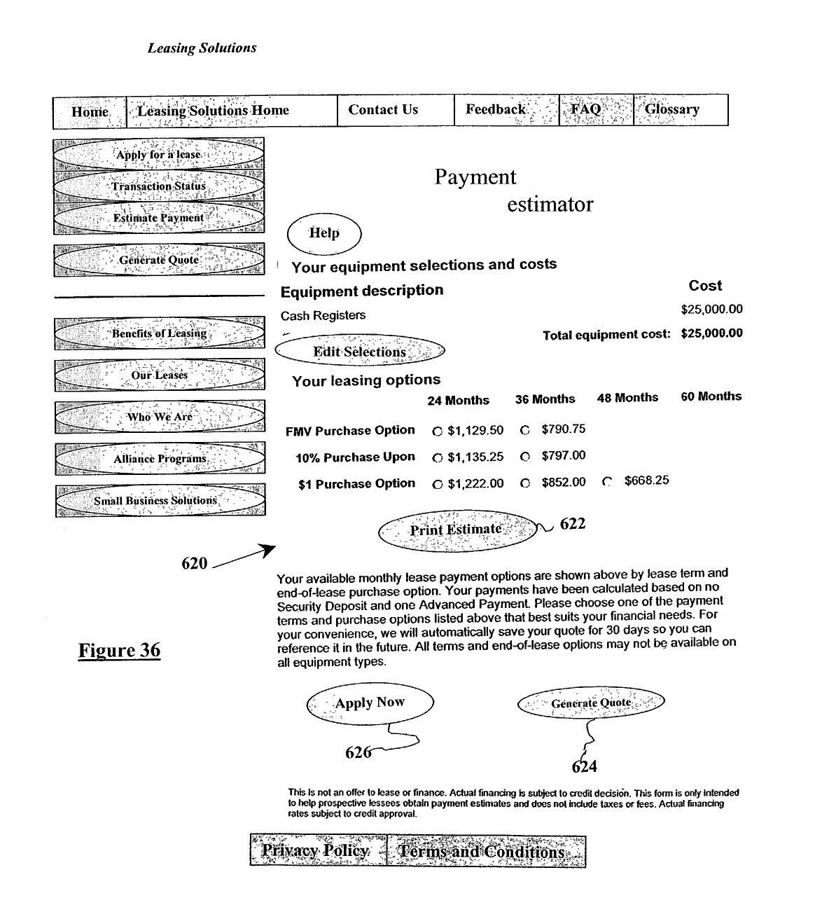

FIG. 36 is an example of a payment estimate interface 620 for lease transaction system 22 (shown in FIG. 2). Interface 620 includes an Equipment description and leasing options. A link 622 is included for printing the payment estimate from client system 14. Further, payment estimate interface 620 includes a link 624 to a quote generator option interface 630 (shown in FIG. 36). A user accesses a lease application through link 626.

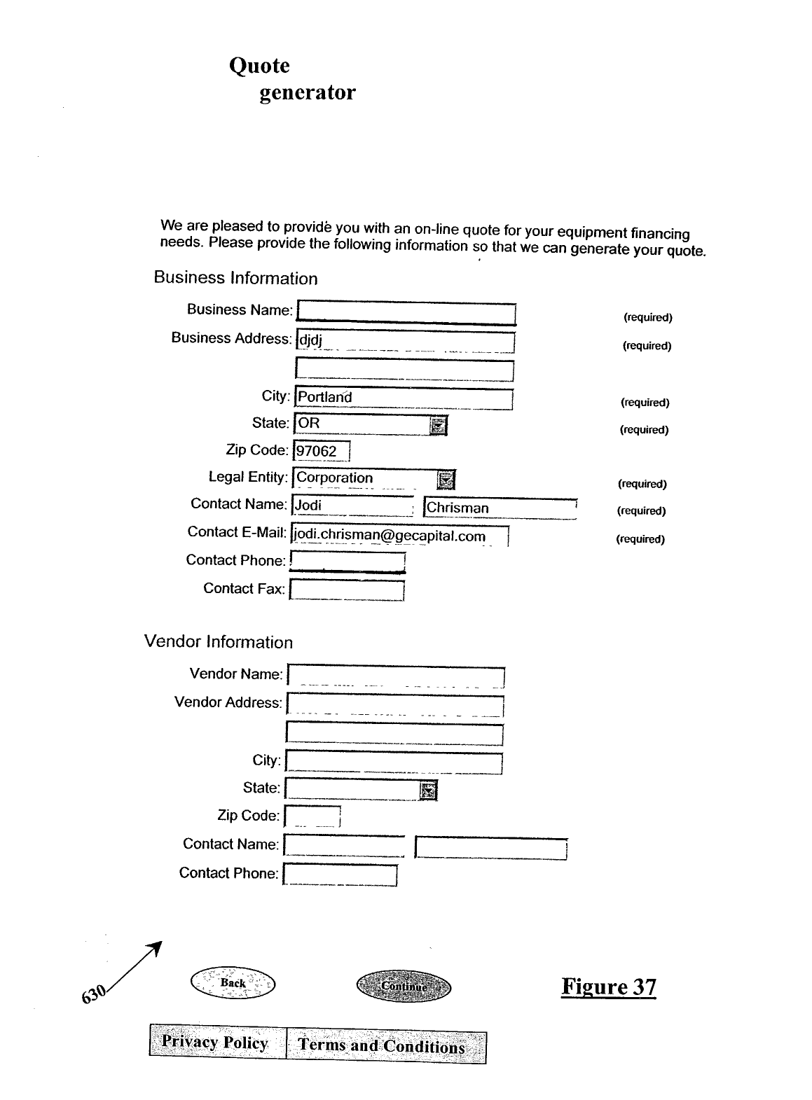

FIG. 37 is an example of a quote generator option interface 630 for lease transaction system 22 (shown in FIG. 2). Interface 630 is accessible from client system 14 and includes inputs for Business Information and Vendor Information.

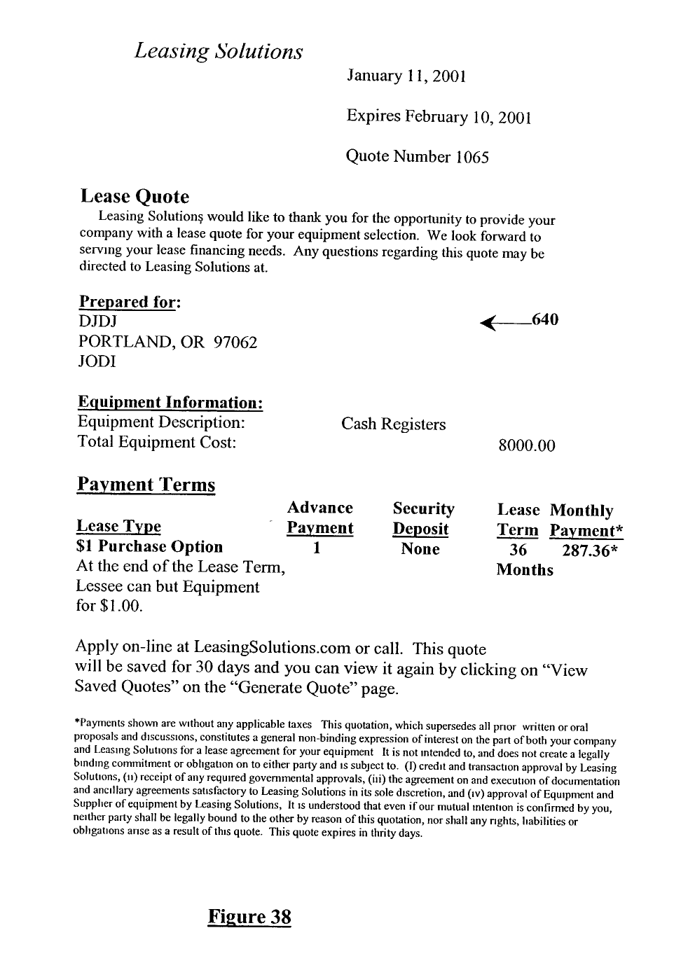

FIG. 38 is an example of a pricing document 640. Pricing document 640 includes Equipment information, Payment Terms, the customer name, the lessor name, the quote date, and the quote expiration date.

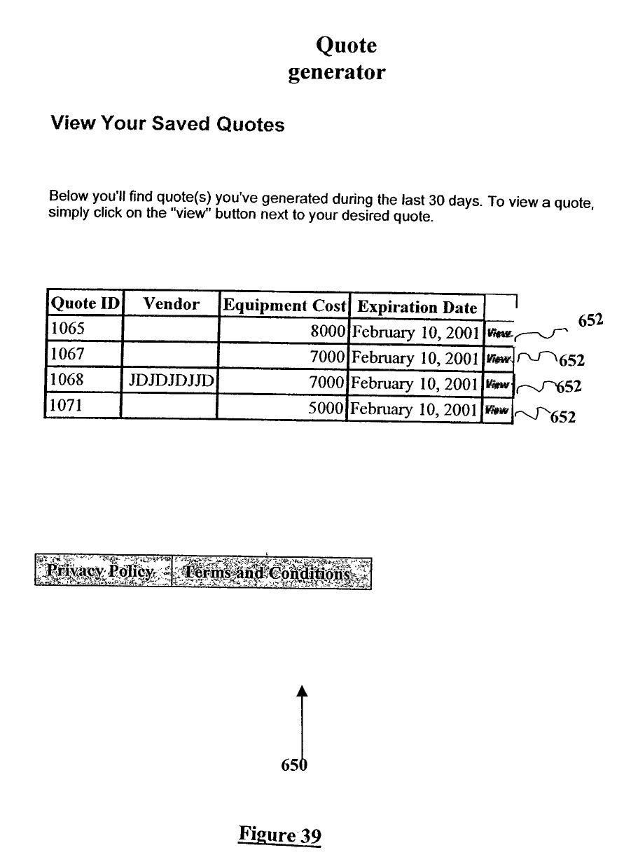

FIG. 39 is an example of a view saved quotes interface 650 for lease transaction system 22 (shown in FIG. 2). Interface 650 includes all pricing documents that a user generates within a 30-day period. Interface 650 further includes a description of the pricing documents, including Quote ID, Vendor, Equipment Cost, and Expiration Date. Links 652 are provided to allow a user to view a particular pricing document.

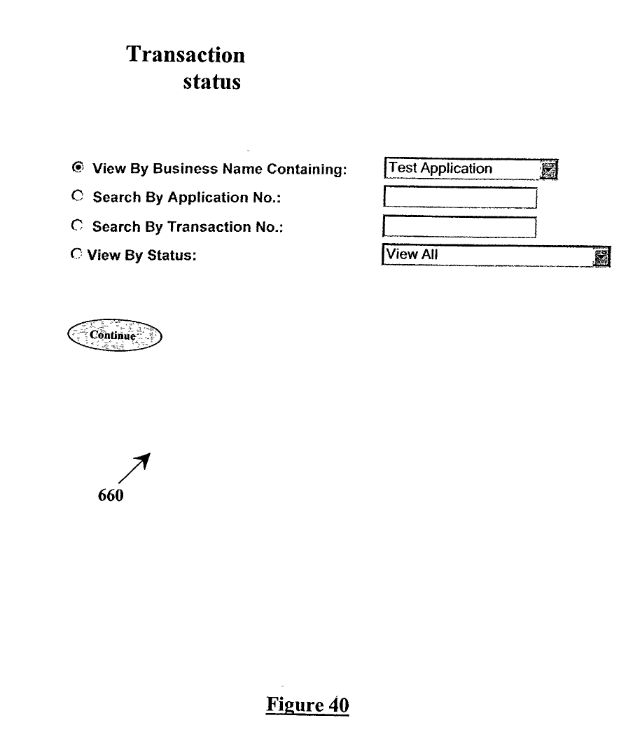

FIG. 40 is an example of a transaction status option interface 660 for lease transaction system 22 (shown in FIG. 2). Interface 660 allows a user to search for a transaction by Business Name, Application Number, or Transaction Number.

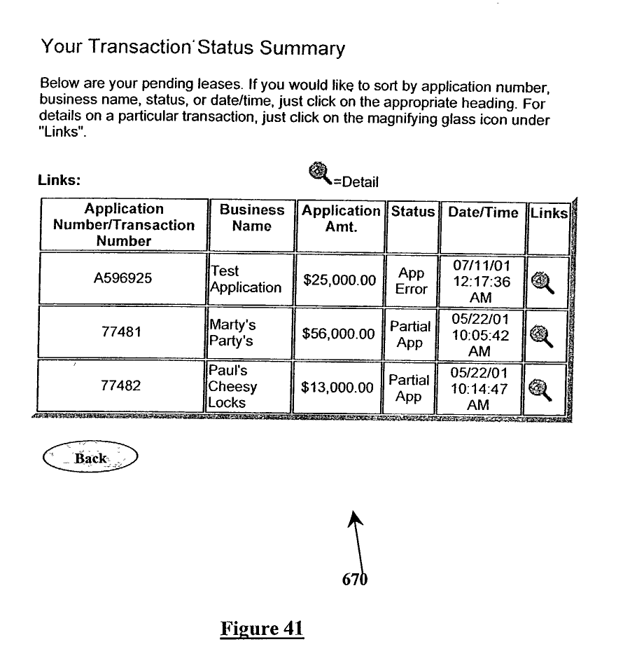

FIG. 41 is an example of a transaction status interface 670 for lease transaction system 22 (shown in FIG. 2). Interface 670 includes links to all of a user's pending lease transactions. The transactions are described by Application Number, Business Name, Application Amount, Status, and Date/Time.

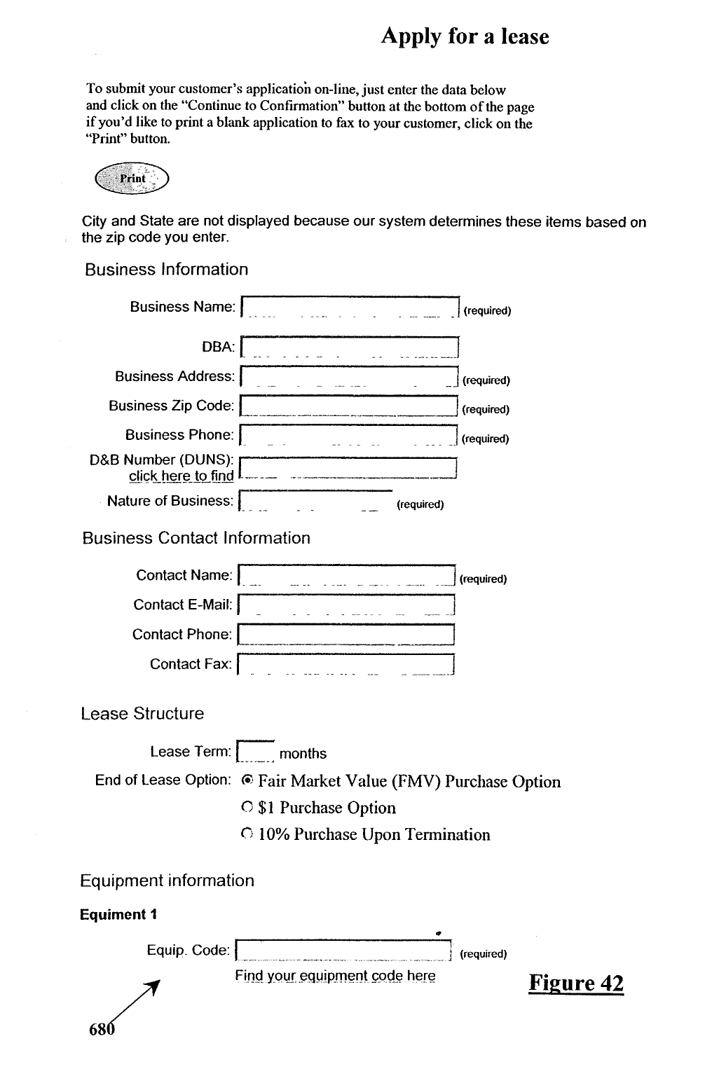

FIG. 42 is an example of a vendor lease application interface 680 for lease transaction system 22 (shown in FIG. 2). Vendor lease application interface 680 represents the first page of an on-line vendor lease application and is accessible from client system 14. Interface 680 includes inputs for Business Information, Business Contact Information, Equipment Information, and Lease Structure.

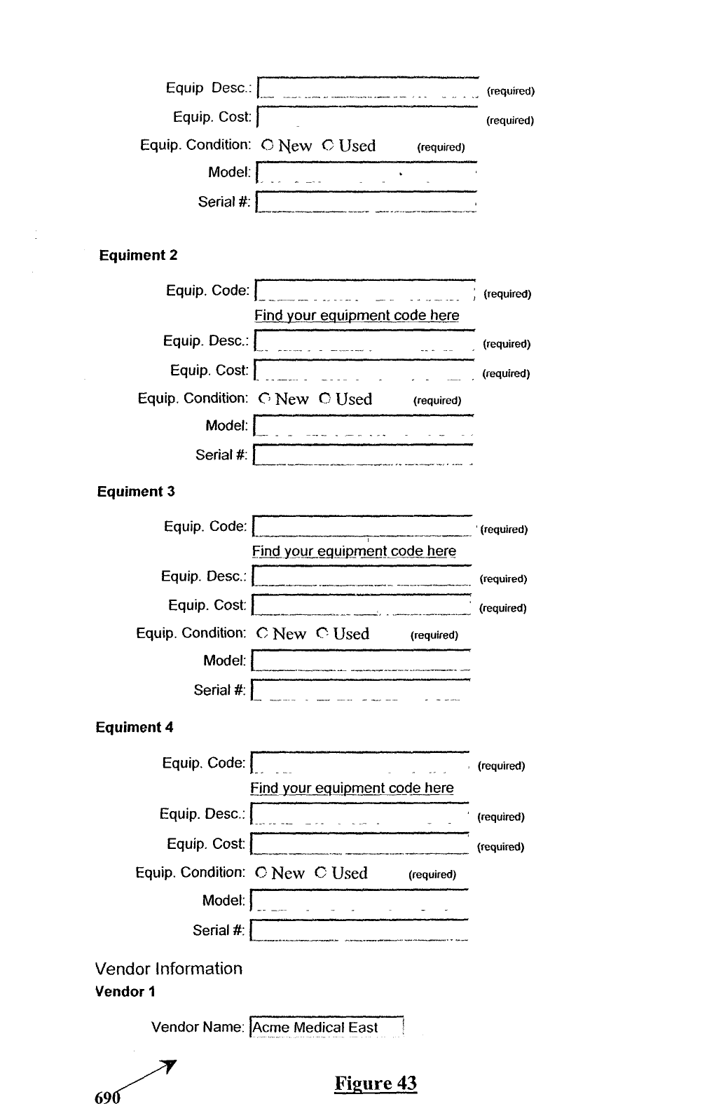

FIG. 43 is an example of a vendor lease application interface 690 for lease transaction system 22 (shown in FIG. 2). Interface 690 represents the second page of an on-line vendor lease application and is accessible from client system 14. Interface 690 includes inputs for Equipment Information and Vendor Information. The Equipment Information inputs include inputs for an Equipment Code, an Equipment Description, an Equipment Cost, an Equipment Condition, an Equipment Model, and an Equipment Serial number.

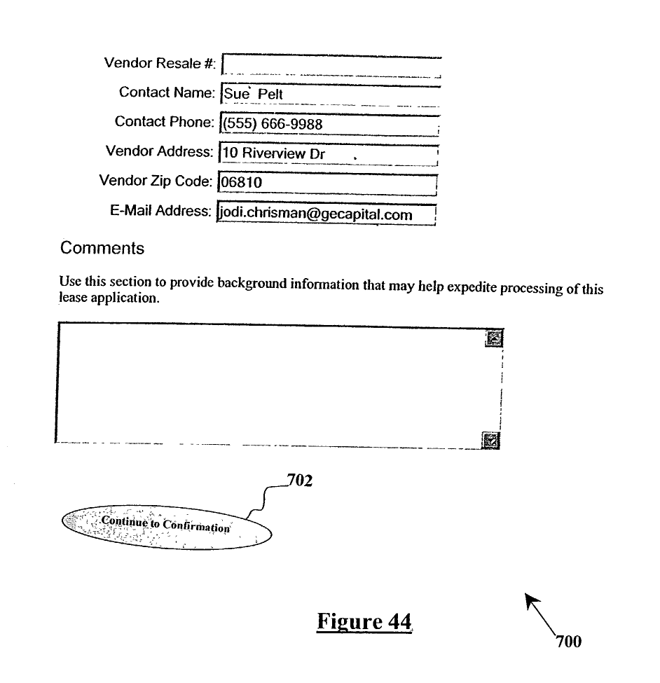

FIG. 44 is an example of a vendor lease application interface 700 for lease transaction system 22 (shown in FIG. 2). Interface 700 represents the third page of an on-line vendor lease application and is accessible from client system 14. Interface 700 includes inputs for Comments and a link 702 for submitting the partially completed lease application.

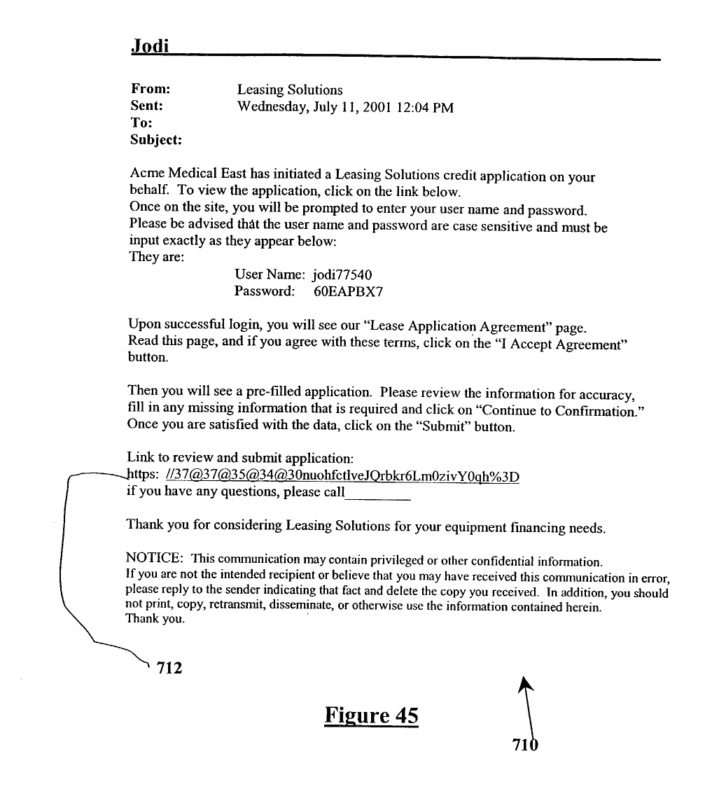

FIG. 45 is an example of an electronic mail notification 710 to a customer that a vendor has submitted a partially completed lease application to server system 12. The electronic mail notification includes a valid customer name, a valid customer password, and instructions for submitting a fully completed application to server system 12. The electronic mail notification further includes a link 712 configured to access the partially completed lease application using a client system 14, such that a customer can view, modify, and fully complete the partially completed lease application using the client system 14.

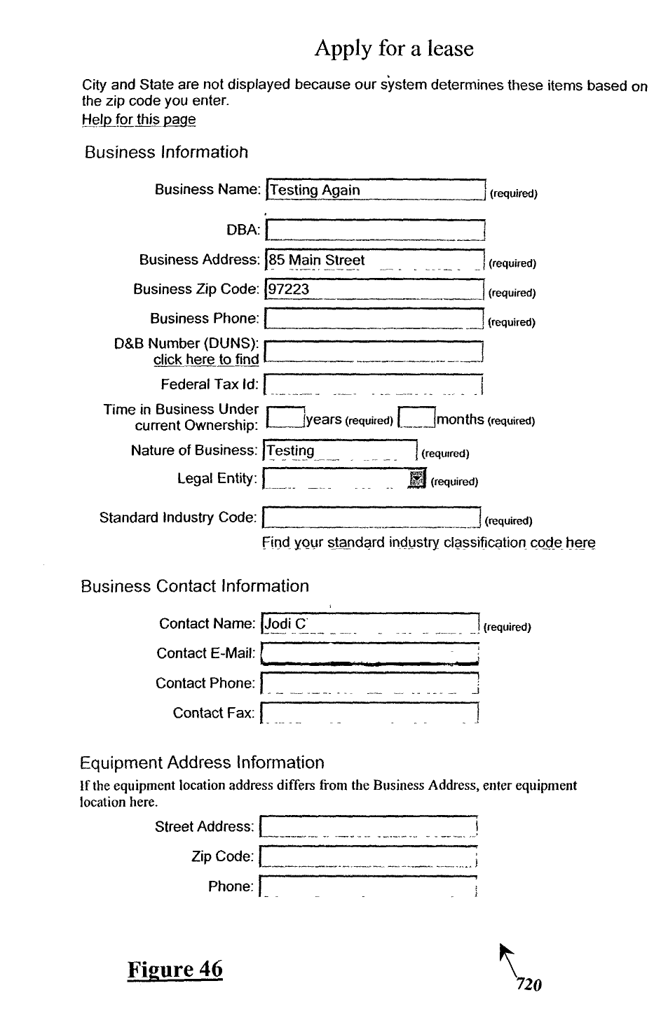

FIG. 46 is an example of a partially completed lease application interface 720 for lease transaction system 22 (shown in FIG. 2). Interface 720 represents the first page of a partially completed lease application and is accessible from client system 14. Interface 720 includes inputs for Business Information, Business Contact Information, Equipment Address Information, and Personal Information.

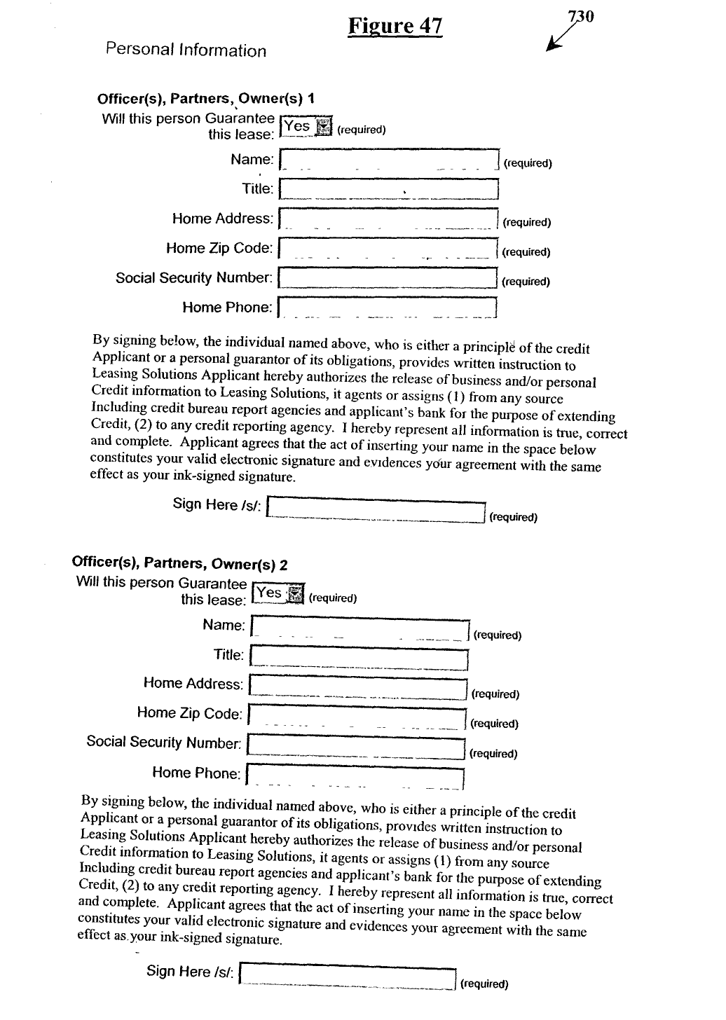

FIG. 47 is an example of a partially completed lease application interface 730 for lease transaction system 22 (shown in FIG. 2). Interface 730 represents the second page of a partially completed lease application and is accessible from client system 14. Interface 730 includes inputs for Officer, Partner, and Owner information, and Bank Information.

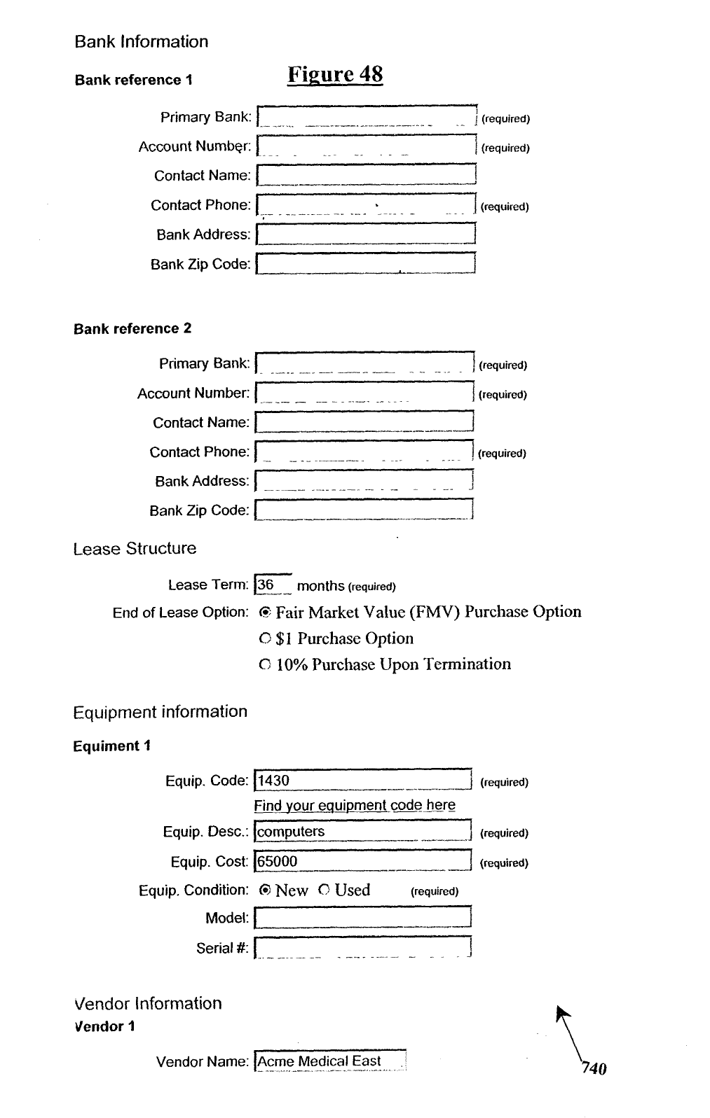

FIG. 48 is an example of a partially completed lease application interface 740 for lease transaction system 22 (shown in FIG. 2). Interface 740 represents the third page of a partially completed lease application and is accessible from client system 14. Interface 740 includes inputs for Bank references, Lease Structure, Equipment Information and Vendor Information. The Equipment Information inputs include inputs for an Equipment Code, an Equipment Description, an Equipment Cost, an Equipment Condition, an Equipment Model, and an Equipment Serial number.

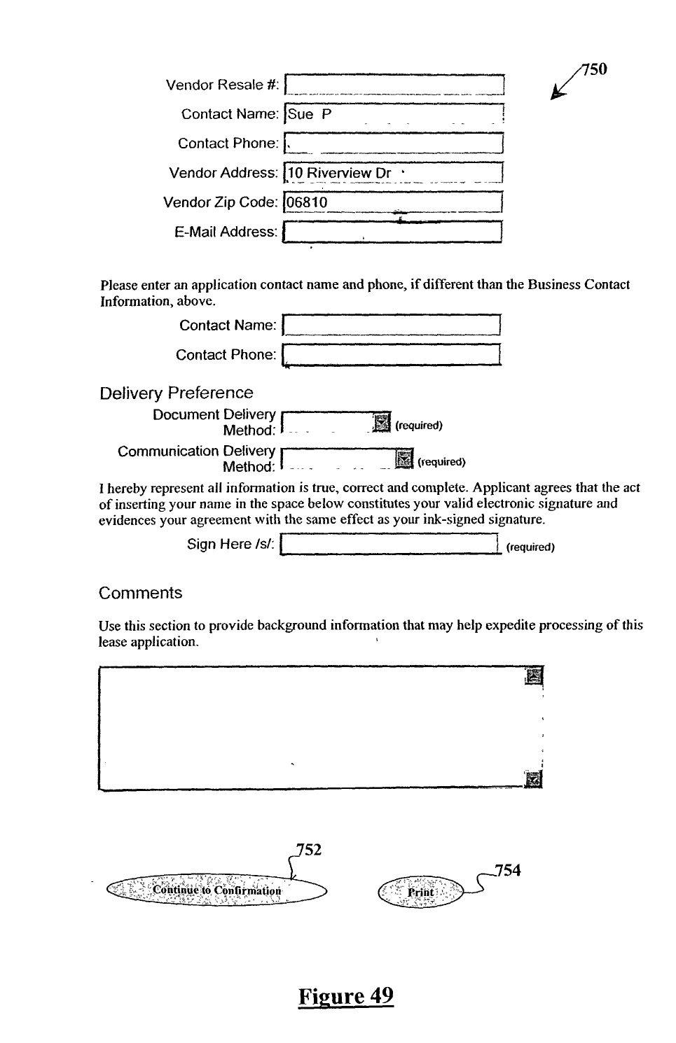

FIG. 49 is an example of a partially completed lease application interface 750 for lease transaction system 22 (shown in FIG. 2). Interface 750 represents the fourth page of a partially completed lease application and is accessible from client system 14. Interface 750 includes inputs for Vendor Information, Delivery Preference, and Comments. Interface 750 further includes a link 752 for submitting the partially completed lease application, and link 754 for printing the partially completed lease application.

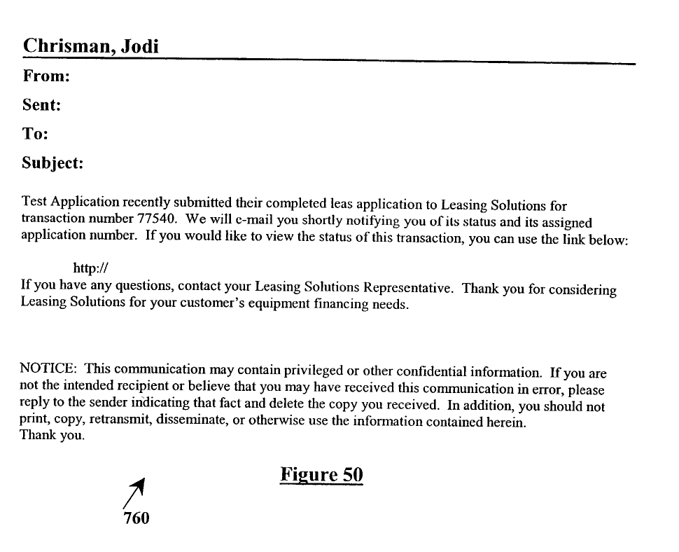

FIG. 50 is an example of an electronic mail notification 760 to a vendor informing the vendor that the customer has submitted a fully completed application to server system 12. The electronic mail notification to the vendor includes the customer's business name, the customer contact name, and the date the fully completed application was submitted to server system 12.

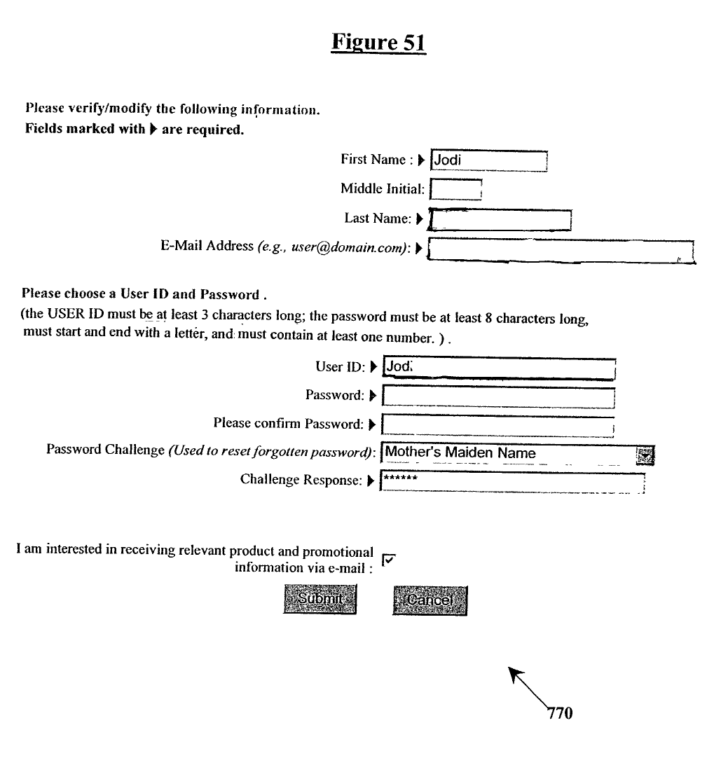

FIG. 51 is an example of a user account modification or set-up interface 770 for lease transaction system 22 (shown in FIG. 2). Interface 770 allows a user to view and modify the user's first name, middle initial, last name, electronic mail address, user name (or user ID), user password, and challenge response.

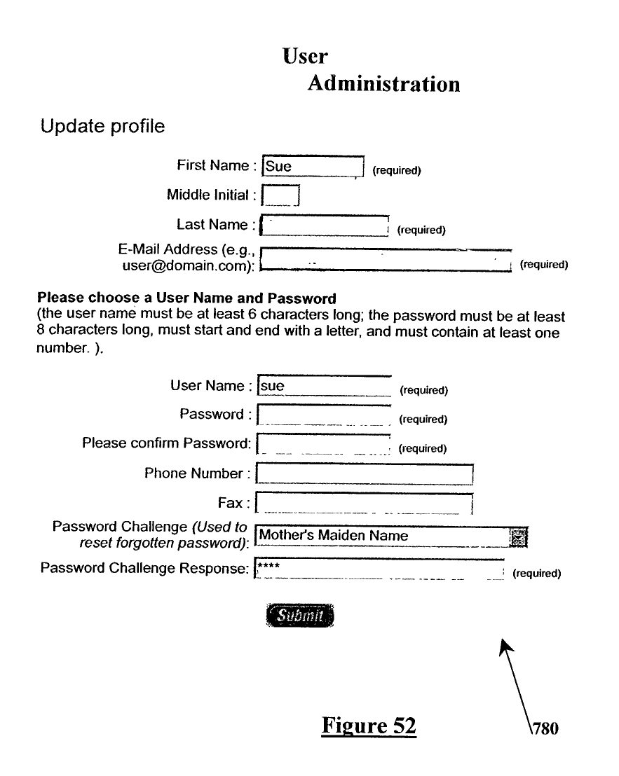

FIG. 52 is an example of a user update profile interface 780 for lease transaction system 22 (shown in FIG. 2). Interface 780 allows a user to view and modify the user's first name, middle initial, last name, electronic mail address, user name (or user ID), user password, and challenge response.

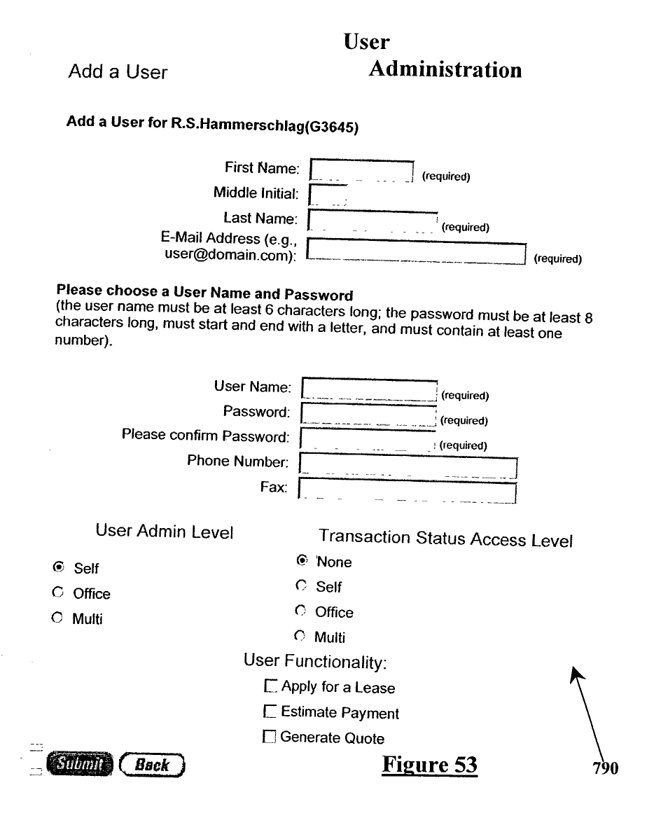

FIG. 53 is an example of an add a user to an office interface 790 for lease transaction system 22 (shown in FIG. 2). Interface 790 allows a user to add a user to an office. Interface 790 also allows a user to view and complete the user profile, including the user's UAL a user transaction status level, for the user being added to the office.

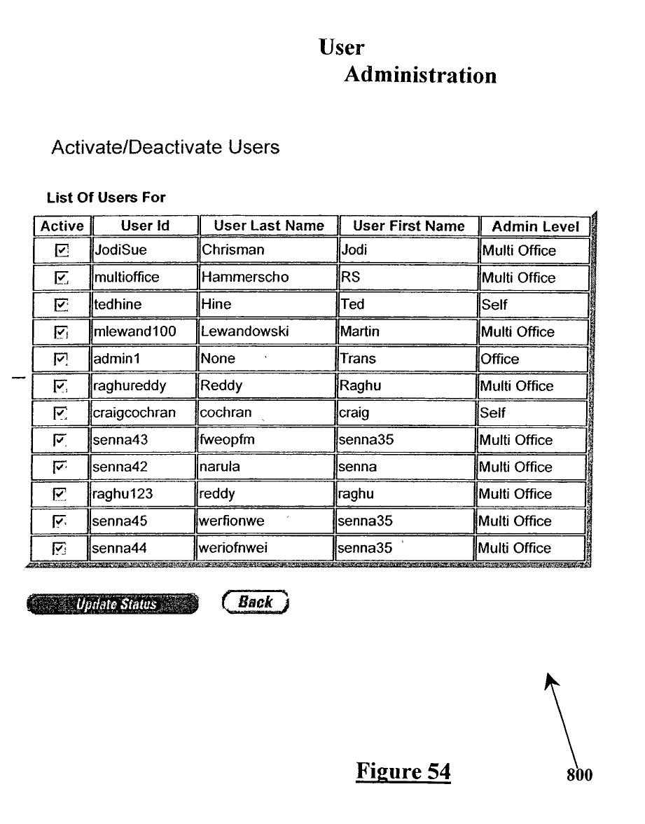

FIG. 54 is an example of an activate/deactivate user interface 800 for lease transaction system 22 (shown in FIG. 2). Interface 800 allows a user to activate or deactivate users within the client.

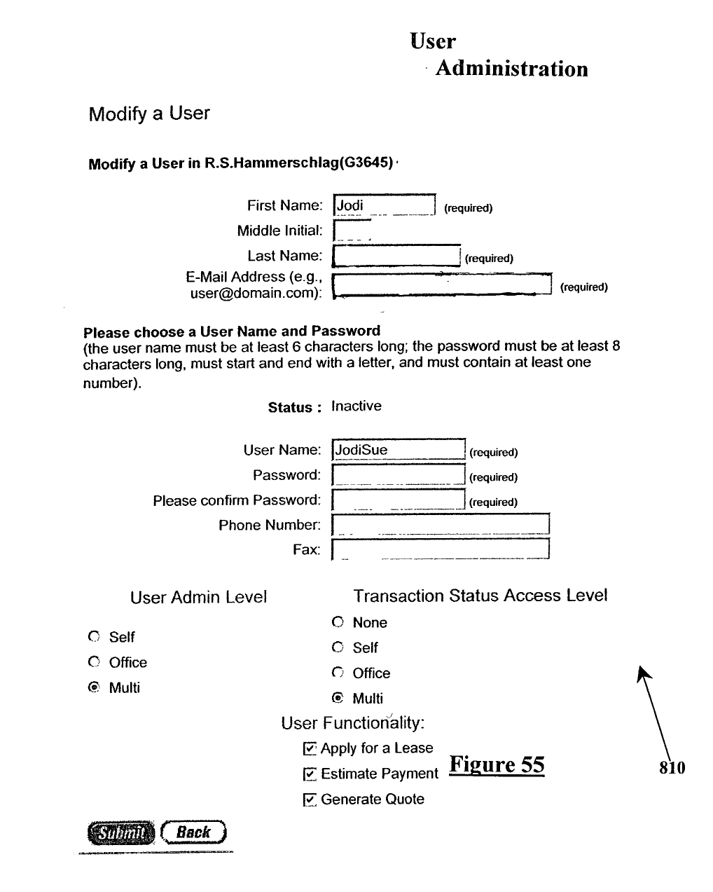

FIG. 55 is an example of a modify a user interface 810 for lease transaction system 22 (shown in FIG. 2). Interface 810 allows a user to modify a user's profile, including the user's UAL

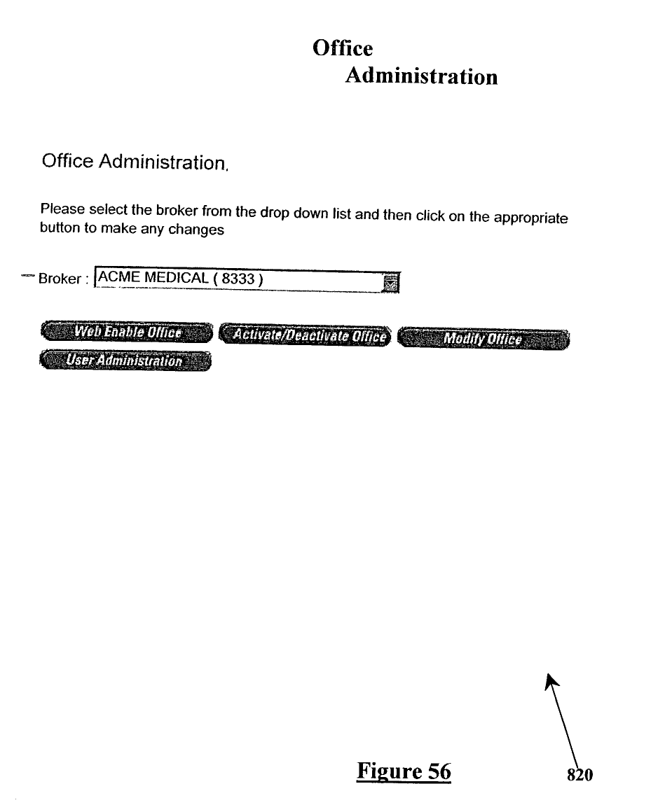

FIG. 56 is an example of office selection interface 820 for lease transaction system 22 (shown in FIG. 2). Interface 820 allows a user to select an office and web enable the office, activate or deactivate the office, or modify the office.

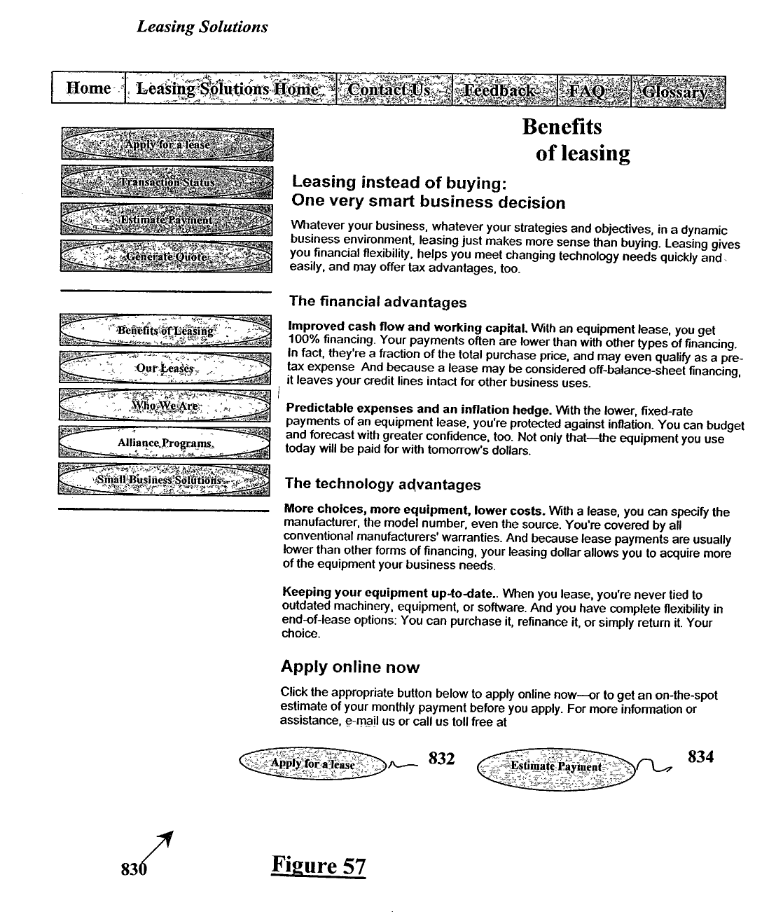

FIG. 57 is an example of a Benefits of leasing interface 830 for lease transaction system 22 (shown in FIG. 2). Interface 830 explains the benefits of leasing instead of buying. Interface 830 further includes a link 832 to an on-line lease application and a link 834 to a payment estimator option.

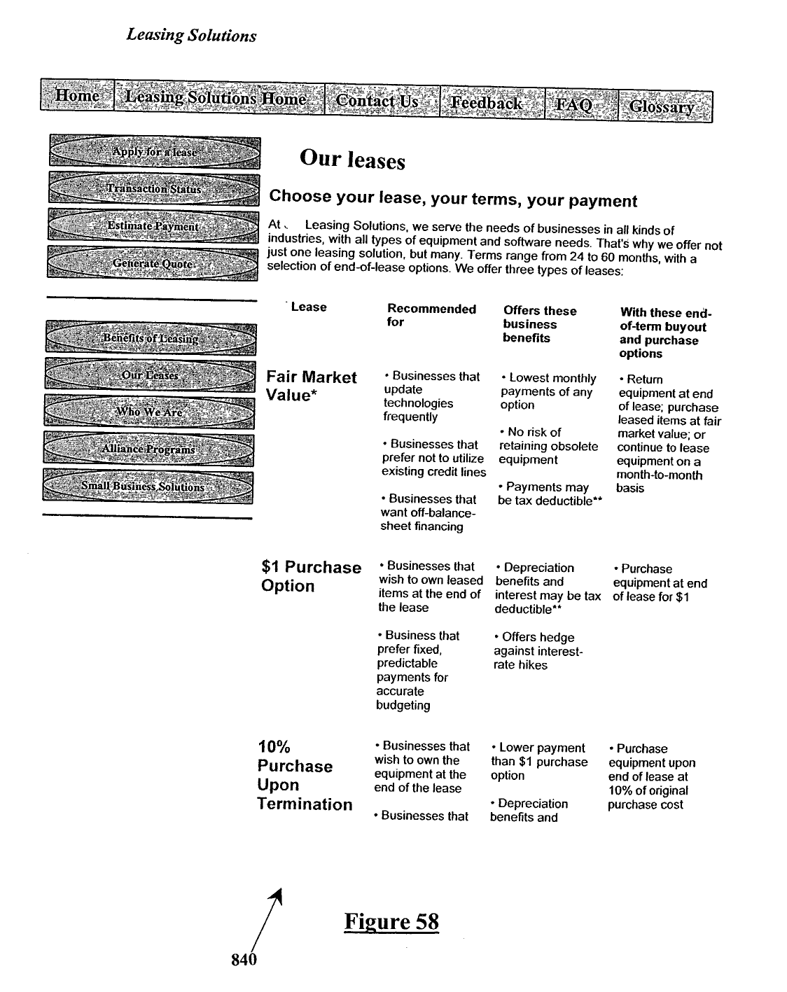

FIG. 58 is an example of an Our leases interface 840 for lease transaction system 22 (shown in FIG. 2). Interface 840 represents the first page of an Our Leases section that explains different types leases and related information.

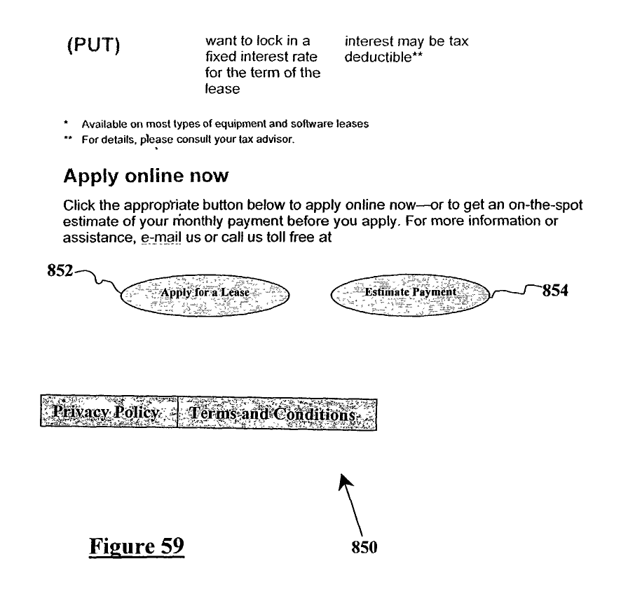

FIG. 59 is an example of an Our leases interface 850 for lease transaction system 22 (shown in FIG. 2). Interface 850 represents the second page of an Our Leases section that explains different types leases and related information. Interface 850 includes a link 852 to an on-line lease application and a link 854 to a payment estimator option.

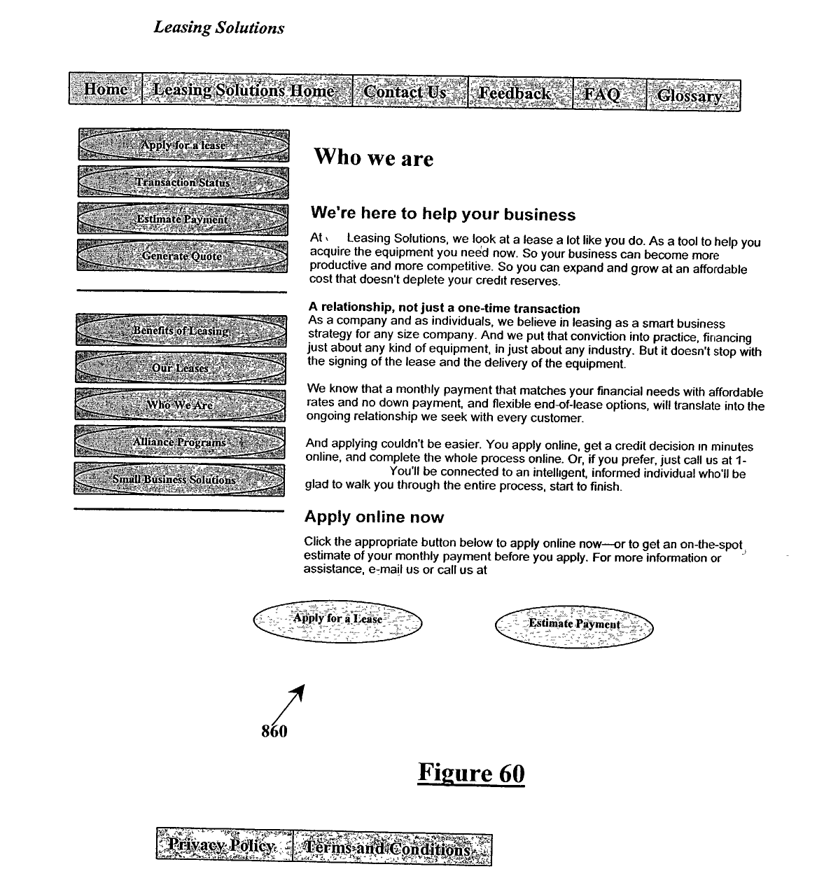

FIG. 60 is an example of a Who we are interface 860 for lease transaction system 22 (shown in FIG. 2). Interface 860 explains how leasing transaction system 22 can help a business.

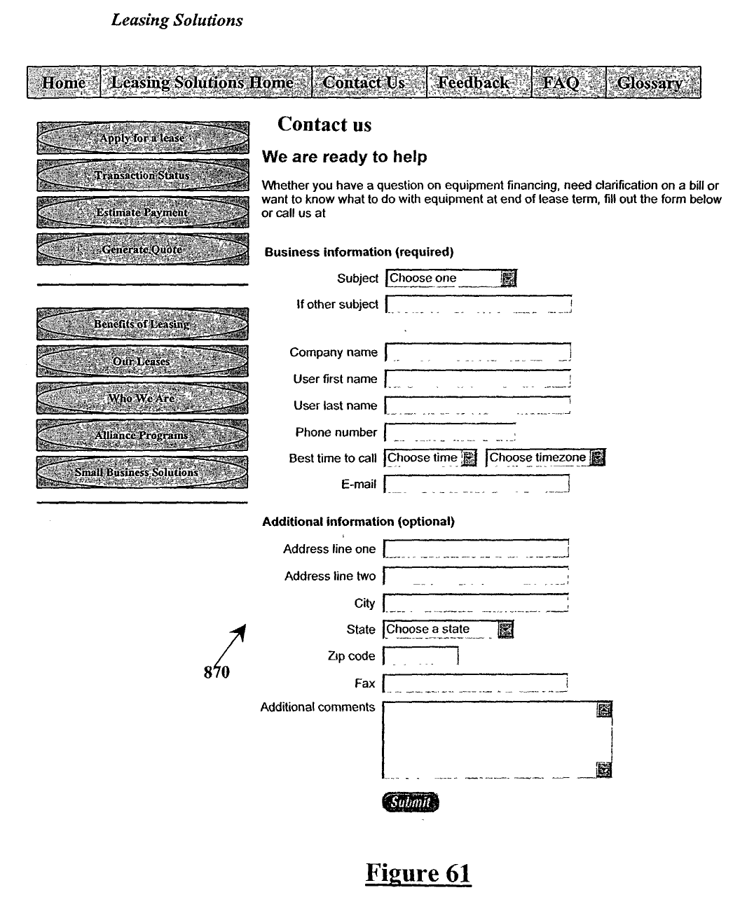

FIG. 61 is an example of a Contact us interface 870 for lease transaction system 22 (shown in FIG. 2). Interface 870 includes inputs for Business Information and Additional Information to facilitate communication between the user and lease transaction system 22.

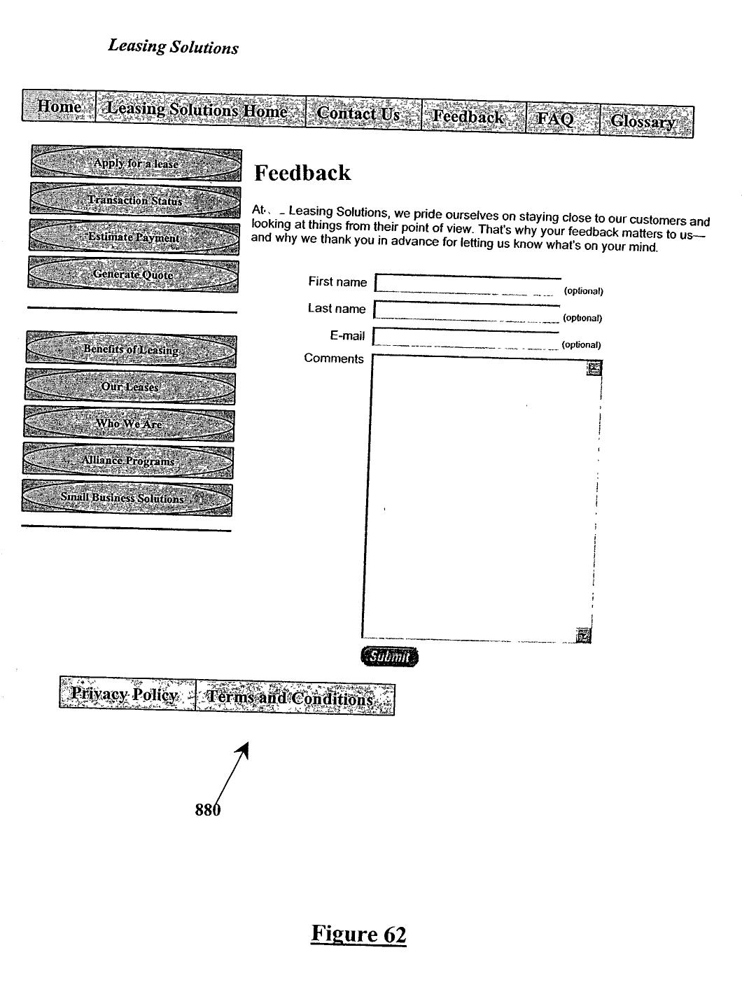

FIG. 62 is an example of a Feedback interface 880 for lease transaction system 22 (shown in FIG. 2). Interface 880 includes inputs for First name, Last name, E-mail and Comments. Interface 880 allows users to communicate feedback regarding lease transaction system 22 to system 12 using client system 14.

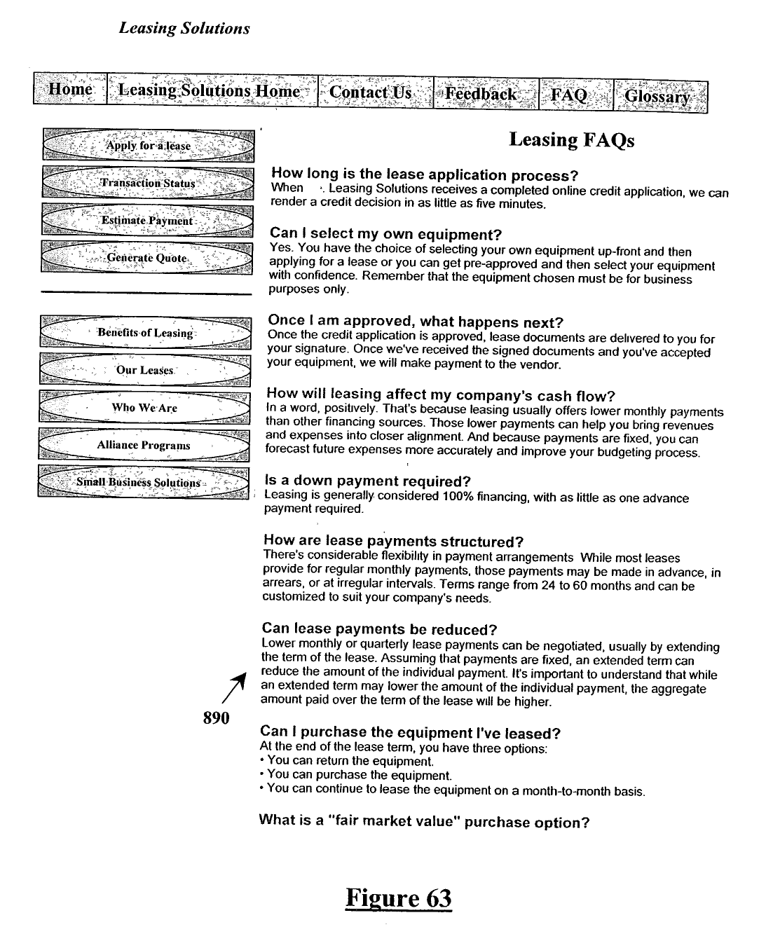

FIG. 63 is an example of a Leasing FAQ interface 890 for lease transaction system 22 (shown in FIG. 2). Interface 890 answers common questions regarding leases.

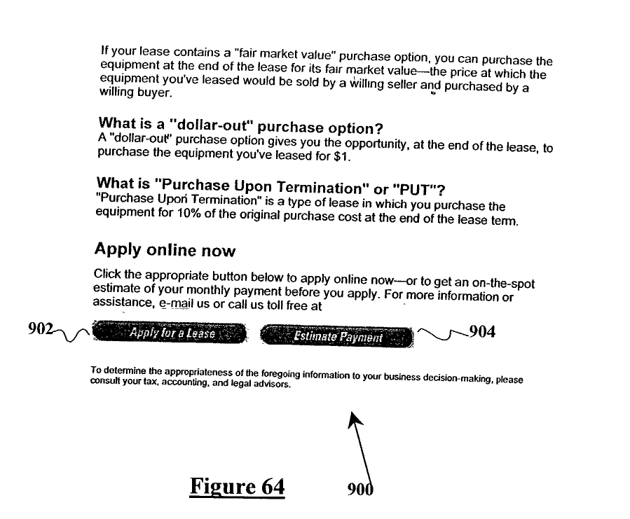

FIG. 64 is an example of a Leasing FAQ interface 900 for lease transaction system 22 (shown in FIG. 2). Interface 900 answers common questions regarding leases. Interface 900 includes a link 902 to an on-line lease application and a link 904 to a payment estimator option.

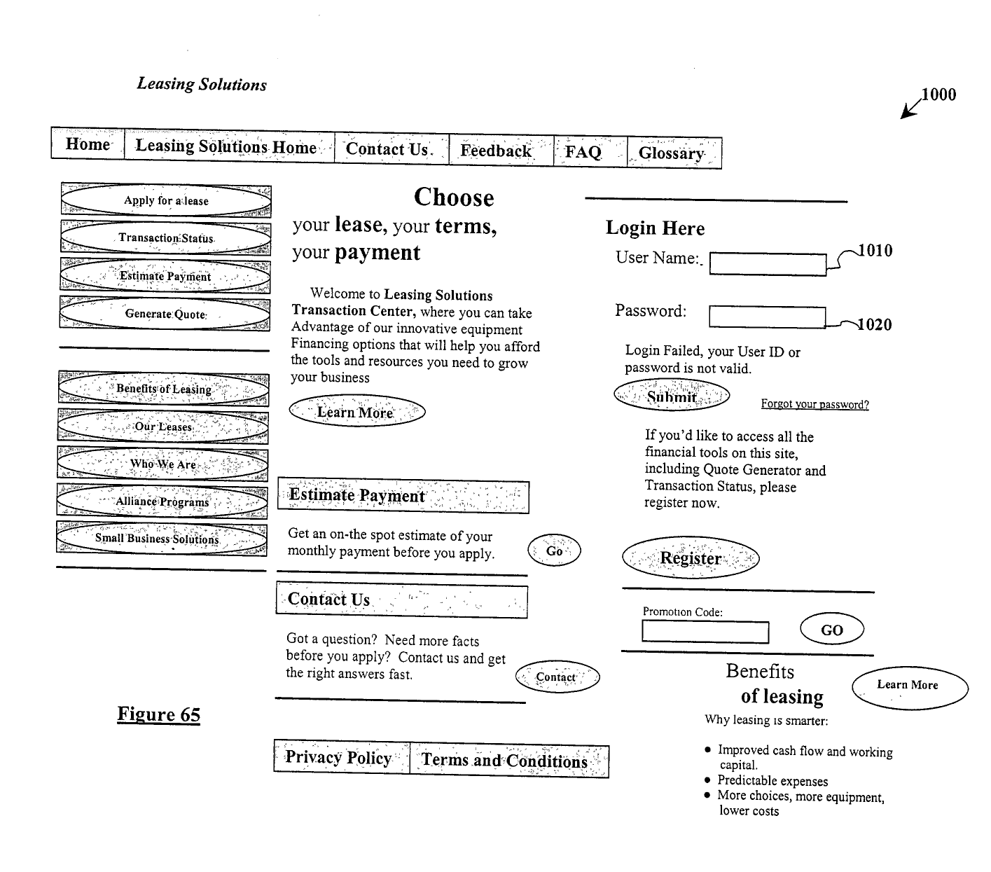

FIG. 65 is an example of a CNA login interface 1000 for lease transaction system 22 (shown in FIG. 2). Interface 1000 includes inputs 1010, 1020, respectively, for a user name and a user password.

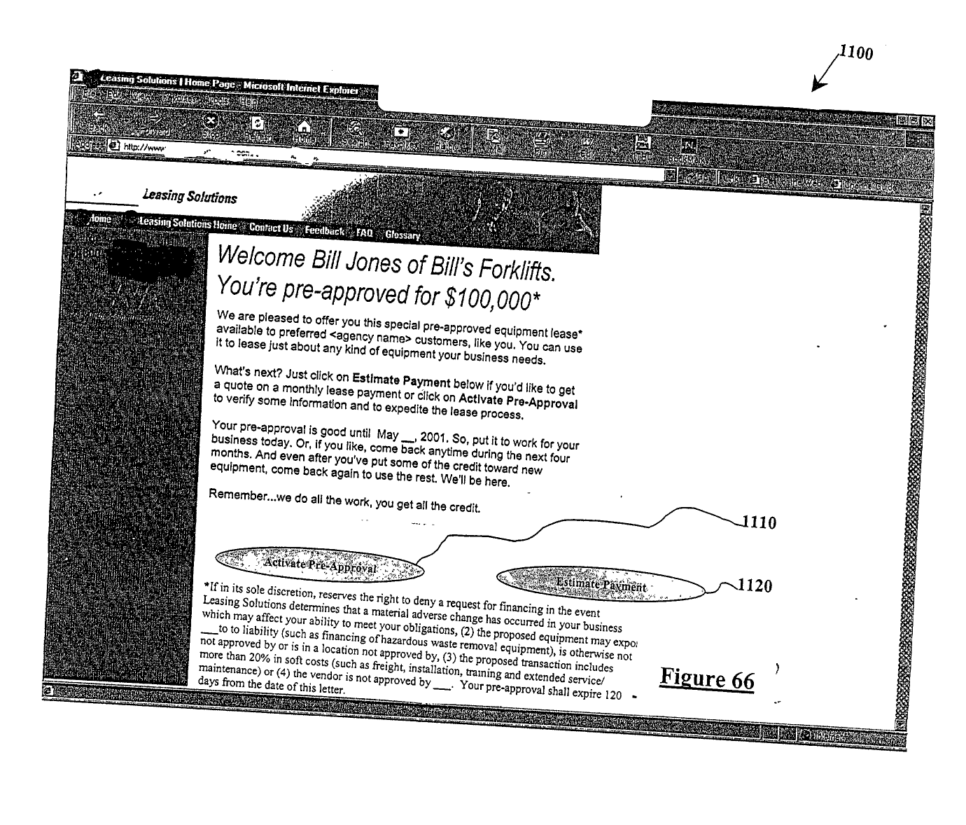

FIG. 66 is an example of a CNA pre-approval interface 1100 for lease transaction system 22 (shown in FIG. 2). Interface 1100 includes a link 1110 to activate the pre-approval and a link 1120 to estimate payment.

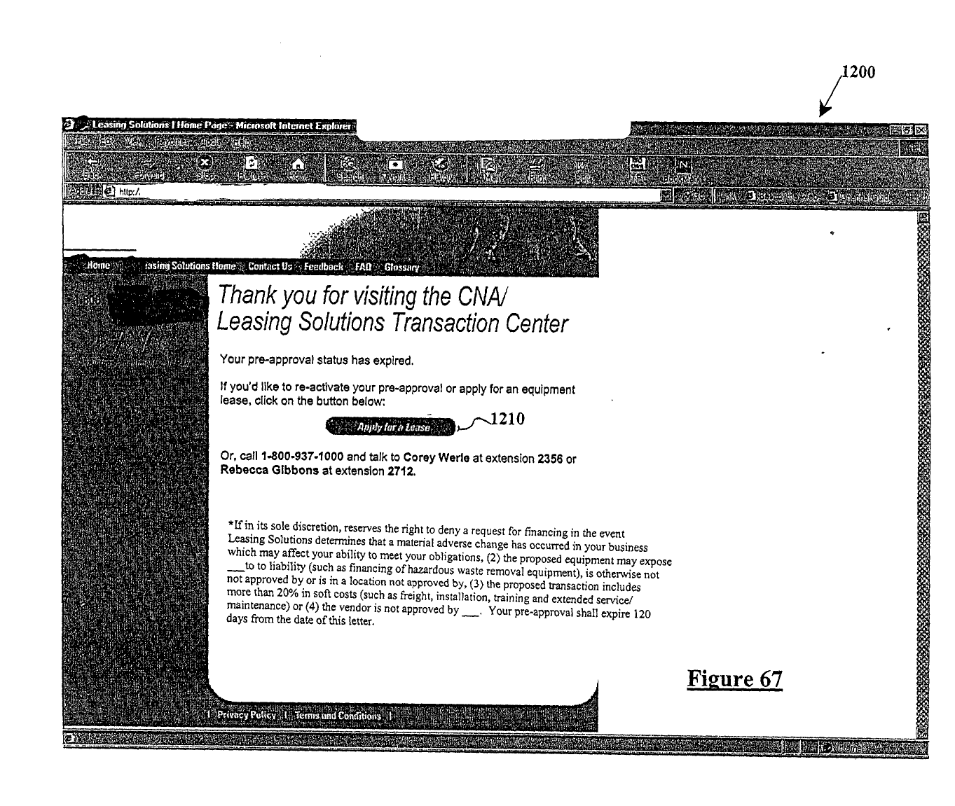

FIG. 67 is an example of a CNA pre-approval expiration interface 1200 for lease transaction system 22 (shown in FIG. 2). Interface 1200 includes a link 1210 to apply for a lease.

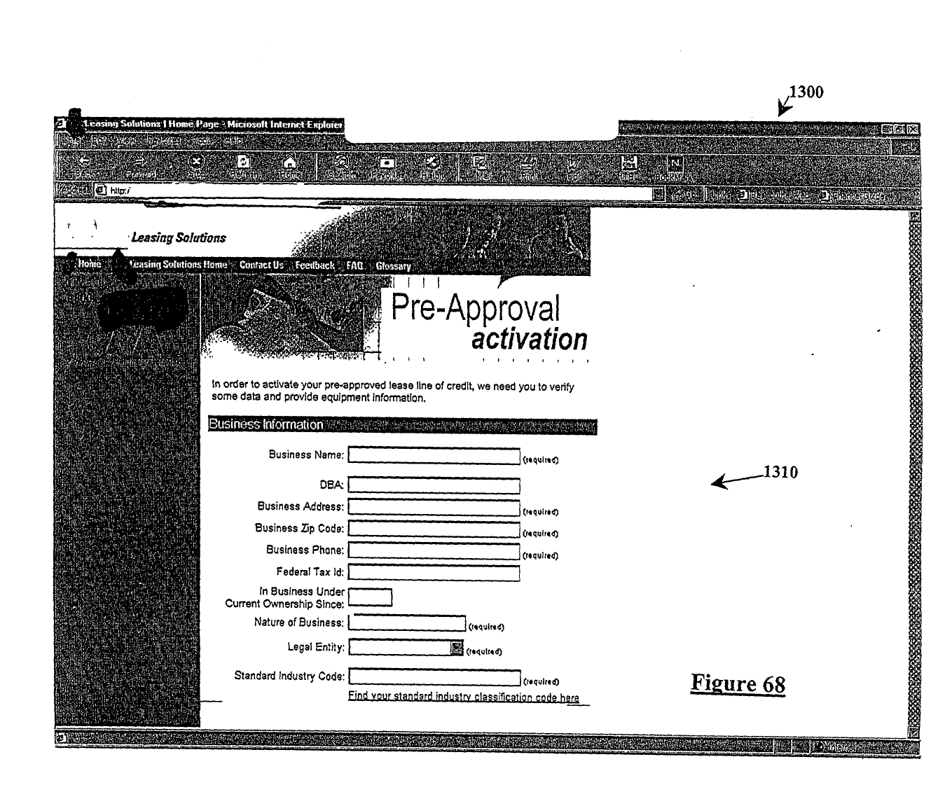

FIG. 68 is an example of a pre-approval activation interface 1300 for lease transaction system 22 (shown in FIG. 2). Interface 1300 represents the first page of a pre-approval activation and is accessible from client system 14. Interface 1300 includes inputs 1310 for Business Information.

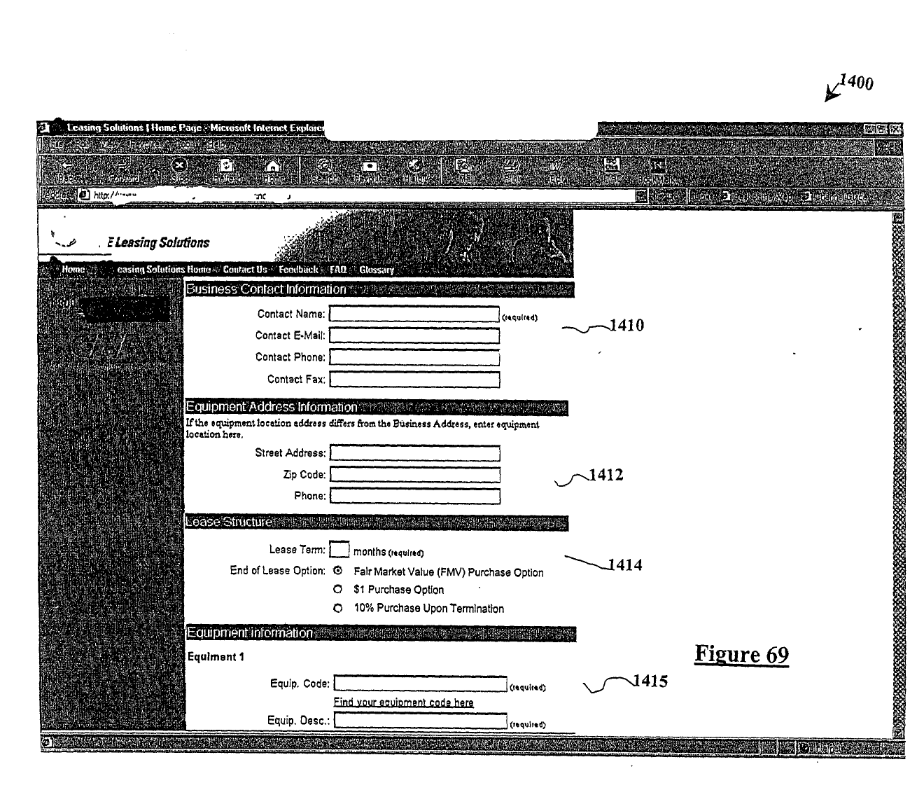

FIG. 69 is an example of a pre-approval activation interface 1400 for lease transaction system 22 (shown in FIG. 2). Interface 1400 represents the second page of a pre-approval activation and is accessible from client system 14. Interface 1400 includes inputs 1410, 1412, 1414, and 1415, respectively, for Business Contact Information, Equipment Address Information, Lease Structure, and Equipment Information.

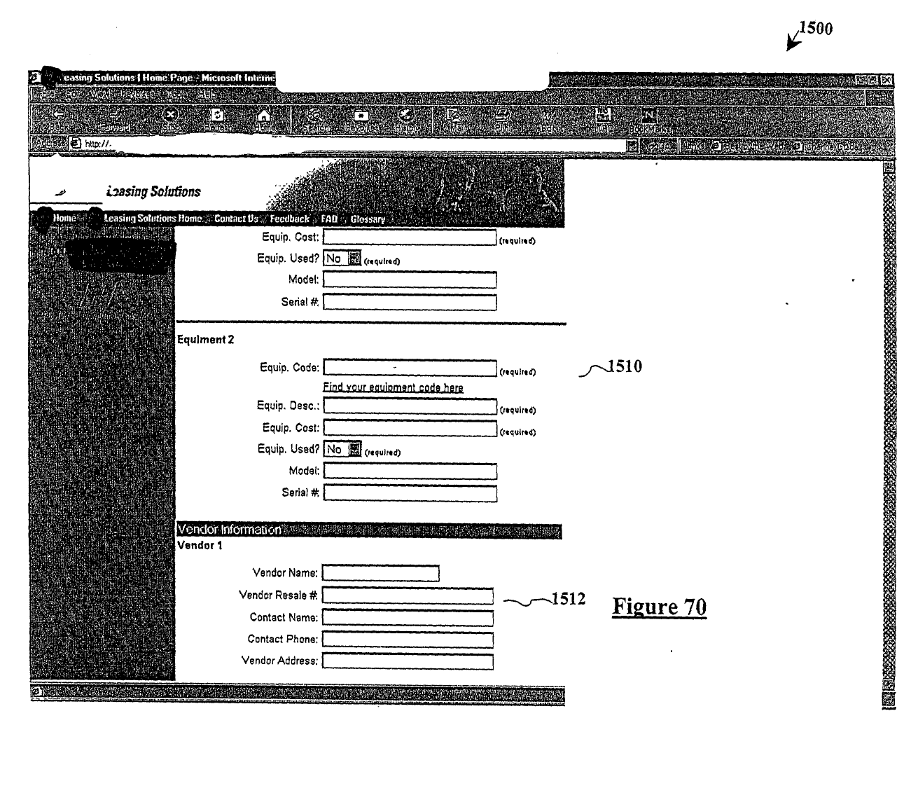

FIG. 70 is an example of a pre-approval activation interface 1500 for lease transaction system 22 (shown in FIG. 2). Interface 1500 represents the third page of a pre-approval activation and is accessible from client system 14. Interface 1500 includes inputs 1510, 1512 respectively, Equipment Information and Vendor Information.

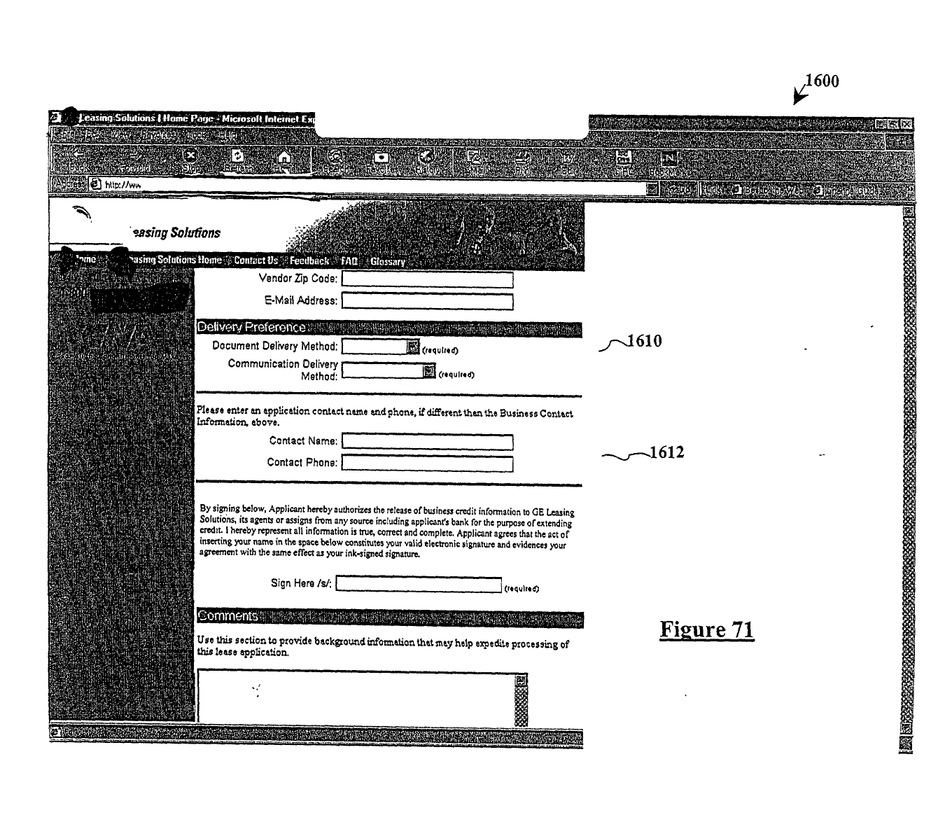

FIG. 71 is an example of a pre-approval activation interface 1600 for lease transaction system 22 (shown in FIG. 2). Interface 1600 represents the fourth page of a pre-approval activation and is accessible from client system 14. Interface 1600 includes inputs 1610, 1612, respectively, for Delivery Preference and Comments.

While the invention has been described in terms of various specific embodiments, those skilled in the art will recognize that the invention can be practiced with modification within the spirit and scope of the claims.

What is claimed is:

1. A method for equipment lease processing and management, using a network-based system and at least one client system configured to communicate with the network-based system, said method comprising:
providing a lease application on the network-based system, the lease application configured to be completed using the client system, and submitted to the network using the client system;
processing a completed lease application using the network based system; and
displaying on the client system the results of said processing of the completed lease application, using the network-based system.

2. A method in accordance with claim 1 wherein the network-based system includes a database, said method further comprising:
storing user names, user passwords, and user profiles in the database;
requiring a user to enter a valid user name and a valid user password to access the network-based system and a lease application; and
comparing an entered user name and an entered user password with user names and user passwords stored in the database to determine a user's profile.

3. A method in accordance with claim 1 further comprising:
displaying on the client system the legal terms and conditions for the application; and
requiring the user accept the legal terms and conditions to access to the lease application.

4. A method in accordance with claim 1 wherein displaying on the client system the results of said processing of the completed lease application further comprising:
providing the user a choice of the method of notification; and
notifying the user of the results of said processing of the completed lease application using the chosen method of notification.

5. A method in accordance with claim 4 wherein the chosen method of notification is electronic mail, said method further comprising notifying the user of the results of said processing of the completed lease application using electronic mail.

6. A method in accordance with claim 2 further comprising:
providing the user with a transaction status option, the transaction status option allowing the user to check the status of the completed lease application after the lease application has been submitted, using the network-based system and the client system; and
displaying the status of the completed lease application on the client system, using the network-based system.

7. A method in accordance with claim 6 wherein the transaction status option indicates when lease applications have been appealed, approved, have errors, have been declined, are funded, and are in process and under review.

8. A method in accordance with claim 7 wherein different users are allowed different levels of access to the transaction status option and the ability of a user to access a transaction status is defined by the user profile.

9. A method in accordance with claim 1 further comprising:
providing the user with a payment estimator option, the payment estimator option allowing the user to determine a payment estimate for a lease based on user defined inputs and rate information; and
displaying the payment estimate on the client system, using the network-based system.

10. A method in accordance with claim 9 wherein the network-based system includes a database with user passwords, user names, and user profiles stored in the database, said method further comprising:
comparing an entered user name and an entered user password with user names and user passwords stored in the database to determine a user profile; and
determining the rate information at least partially from the user profile.

11. A method in accordance with claim 9 wherein the network-based system includes a database and the user defined inputs are stored in the database, the user defined inputs including equipment types and equipment costs.

12. A method in accordance with claim 9 wherein the rate information is standard rate information.

13. A method in accordance with claim 9 wherein the rate information includes custom lease rate information corresponding to a particular vendor.

14. A method in accordance with claim 9 further comprising providing only rate information and user defined inputs for a particular vendor when the user accesses the network-based system through a hot link contained in the particular vendor's network-based system.

15. A method in accordance with claim 11 wherein the payment estimate is determined by multiplying the Least Rate Factor (LRF) by the Equipment Costs, wherein:
$$\frac{\begin{matrix}LRF = [ ( PV - FV ) * ( SPPV ( I \% YR \div PPY : N ) ) - \\ ( \$SD - ( \$SD * ( SPPV ( I \% YR \div PPY : N ) ) ) ) ]\end{matrix}}{\begin{matrix}[ ( USPV ( I \% YR \div PPY : N ) - \# ADV ) + \\ \# ADV - ( - \# SC + ( \# SD * ( SPPV ( I \% YR \div PPY : N ) ) ) ) ]\end{matrix}}$$
and where:
PV=Present value
FV=Future value
SPPV=Single Payment Present Value;
1%YR=Annual Interest rate card per the base rate card+Discounts;
PPY=Payments per year;
N Lease Term;
$SD=Used for a $ Amount of a Security Deposit;
#ADV=Number of Advance Payments;
#SD=Number of Security Deposits equal to the payment amount;
N=Term; and
USPV=Uniform Series Present Value.

16. A method in accordance with claim 9 further comprising:
providing the user with a quote builder option, wherein the quote builder option generates a pricing document;
requiring the user enter a valid user name and user password to access the quote builder option; and
displaying the pricing document on the client system, using the network-based system.

17. A method in accordance with claim 16 wherein the pricing document details the customer, the lessor, the equipment vendor, the equipment description including equipment price, the quote date, the quote expiration date, and pricing parameters, said method further comprising displaying the customer, the lessor, the equipment vendor, the equipment description including equipment price, the quote date, the quote expiration date, and pricing parameters on the client system, using the network-based system.

18. A method in accordance with claim 16 wherein the quote builder option accessible through a hot link in the payment estimator option on the client system.

19. A method in accordance with claim 16 wherein the network-based system includes a database, said method further comprising:
storing saved quotes in the database;
providing a view saved quotes option within the quote builder option; and
displaying a saved quote on the client system, using the network-based system.

20. A method for equipment lease processing and management, using a network-based system and at least two client systems configured to communicate with the network-based system, said method comprising:
providing a lease application on the network-based system wherein the lease application is configured to be partially completed using a first client system, and submitted to the network-based system using the first client system;
electronically mailing notification to a customer that a vendor has submitted a partially completed lease application to the network-based system, wherein the electronic mail notification includes a link configured to access the partially completed lease application and submit a fully completed application to the network-based system, using a second client system;
requesting the customer validate and complete the partially completed lease application using the second client system; and
processing the completed application using the network based system.

21. A method in accordance with claim 20 wherein electronically mailing a notification to a customer that a vendor has submitted a partially completed lease application to the network-based system further comprises validating that the partially completed lease application is correct and in the proper form for submission to a customer, using the network-based system.

22. A method in accordance with claim 21 wherein validating the partially completed lease application is correct and in the proper form for submission to a customer, using the network-based system, further comprises prompting the vendor to make any corrections necessary for the partially completed lease application to be in the proper form for submission to a customer.

23. A method in accordance with claim 20 wherein electronically mailing a notification to a customer that a vendor has submitted a partially completed lease application to the network-based system further comprises verifying the partially completed application contains a valid customer electronic mail address, using the network-based system.

24. A method in accordance with claim 20 wherein the electronic mail notification further includes a valid customer name, a valid customer password, and instructions for submitting the completed application to the network-based system.

25. A method in accordance with claim 20 further comprising validating a fully completed application is complete and correct, using the network-based system.

26. A method in accordance with claim 20 further comprising electronically mailing a notification to the vendor that the customer has submitted a fully completed application to the network-based system.

27. A method in accordance with claim 20 wherein the vendor is at least one of a broker and an equipment manufacturer.

28. A method for equipment lease processing and management, using a network-based system and at least one client system configured to communicate with the network-based system, the network-based system including a database, said method comprising:
storing user names, user passwords, and user profiles in the database;
requesting a user to enter a valid user name and a valid user password to access the network-based system;
comparing an entered user name and an entered user password with user names and user passwords stored in the database to determine a user's profile; and
providing access, using the network-based system, to user accounts and user profiles on the client system such that the user can view and modify the user accounts and user profiles using the client system.

29. A method in accordance with claim 28 wherein the user is at least one of an equipment broker, an equipment vendor, and a customer.

30. A method in accordance with claim 28 wherein a user's level of access to the user accounts and user profiles is determined by the determined user's profile.

31. A method in accordance with claim 28 wherein providing access to the user accounts and users profile further comprising displaying the payment history of a lease account on the client system.

32. A method in accordance with claim 28 wherein providing access to the user accounts and user profiles further comprising displaying the credit rating for a lease account on the client system.

33. A method in accordance with claim 28 further comprising:
providing a search option, using the network-based system, configured to search for at least one of a business name, application number, transaction number, and status; and
displaying the search results, using the network-based system, on the client system.

34. A method in accordance with claim 28 wherein providing access to user accounts and user profiles further comprises providing the client system with access to the last three invoices of a lease account.

35. A method in accordance with claim 34 wherein providing the client system with access to the last three invoices of a lease account further comprises allowing the user to at least one of print the three invoices from the client system and view the three invoices on the client system.

36. A method in accordance with claim 28 wherein providing access to user accounts and user profiles further comprises providing access to lease account information on the client system.

37. A method in accordance with claim 36 wherein providing access to lease account information on the client system further comprises displaying account information on the client system.

38. A method in accordance with claim 28 wherein providing access to user accounts and user profiles further comprising:
allowing a user to request an address change using the client system; and
processing the request using the network-based system such that the user's user profile reflects the address change.

39. A method in accordance with claim 28 wherein providing access to user accounts and user profiles further comprising:
displaying user account documentation on the client system; and
allowing the user to print the account documentation from the client system.

40. A method in accordance with claim 28 wherein providing access to user accounts and user profiles further comprising:
allowing a user to request a name change using the client system; and
processing the request using the network-based system such that the user's user profile reflects the name change.

41. A method in accordance with claim 28 wherein providing access to user accounts and user profiles further comprising:
allowing a user to request a current payoff on a lease account using the client system;
processing the request using the network-based system; and
displaying the current payoff information on the client system, the payoff information including amount and expiration date.

42. A method in accordance with claim 41 further comprising allowing the user to print the current payoff information from the client system.

43. A method in accordance with claim 41 wherein processing the request using the network-based system further comprising processing the request according to at least one of the type of lease account and delinquency of the lease account.

44. A system comprising:
at least one computer configured as a server, said server containing a centralized database;
at least one client system connected to said server through a network, said client system configured with a browser;
said centralized database containing user names, user passwords, user profiles, user accounts, and lease transaction information, wherein the user names, user passwords, and user profiles include vendor names, vendor passwords, and vendor profiles;
said server configured to:
require a vendor to enter a valid vendor name and a valid vendor password to access said server and said centralized database;
compare an entered vendor name and an entered vendor password with vendor names and vendor passwords stored in said centralized database to determine a vendor's profile; and
allow the vendor to view and modify the user accounts, user profiles, and lease transaction information on said client system using said browser, wherein the ability of a vendor to view the user accounts, user profiles, and lease transaction information depends on said vendor's profile, and the ability of a vendor to modify the user accounts, user profiles, and lease transaction information depends on said vendor's profile.

45. A system in accordance with claim 44 wherein the vendor is at least one of a broker, an equipment manufacturer, and an internal user.

46. A system in accordance with claim 44 wherein said server further configured to:
allow the vendor to check the status of a lease application; and
display the status of the lease application on said client system using said browser.

47. A system in accordance with claim 46 wherein said server further configured to display on said client system at least one of lease applications that have been appealed, approved, have errors, have been declined, are funded, and are in process and under review.

48. A system in accordance with claim 44 wherein said centralized database further including vendor defined inputs and rate information, said server further configured to:
determine a payment estimate for a lease based on vendor defined inputs and rate information; and
display the payment estimate on said client system using said browser.

49. A system in accordance with claim 48 wherein said rate information includes custom rate information corresponding to a particular vendor's profile, said server further configured to determined said rate information at least partially from said vendor's profile.

50. A system in accordance with claim 48 wherein said user-defined inputs including at least one of equipment types and equipment costs.

51. A system in accordance with claim 48 wherein said rate information is standard rate information.

52. A system in accordance with claim 50, wherein said server further configured to determine said payment estimate by multiplying a Lease Rate Factor (LRF) by the Equipment Costs, wherein:
$$LRF = \frac{[ ( PV - FV ) * ( SPPV ( I \% YR \div PPY : N ) ) - ( \$SD - ( \$SD * ( SPPV ( I \% YR \div PPY : N ) ) ) ) ]}{[ ( USPV ( I \% YR \div PPY : N ) - \# ADV ) + \# ADV - ( - \# SC + ( \# SD * ( SPPV ( I \% YR \div PPY : N ) ) ) ) ]}$$
and where:
PV=Present value;
FV=Future value;
SPPV=Single Payment Present Value;
1%YR=Annual Interest rate card per the base rate card+Discounts;
PPY=Payments per year;
N=Lease Term;
$SD=Used for a $ Amount of a Security Deposit;
#ADV=Number of Advance Payments;
#SD=Number of Security Deposits equal to the payment amount;
N=Term; and
USPV=Uniform Series Present Value.

53. A system in accordance with claim 48, said server further configured to:
generate a pricing document; and
display said pricing document on said client system using said browser.

54. A system in accordance with claim 53 wherein said pricing document details the customer, the lessor, the equipment vendor, the equipment description including equipment price, the quote date, the quote expiration date, and pricing parameters.

55. A system in accordance with claim 53, said centralized database further including saved quotes, said server further configured to display a saved quote on said client system using said browser.

56. A system for lease management by a client comprising:
at least one computer configured as a server, said server containing a centralized database;
at least one client system connected to said server through a network, said client system configured with a browser;
said centralized database containing client names, client passwords, client profiles, client accounts, and lease transaction information, the client including a plurality of users and said centralized database including a plurality of user names, user passwords, user profiles, and user accounts for the client;
said server configured to:
require a user to enter a valid user name and a valid user password into said client system to access said server and said centralized database;
compare an entered user name and an entered user password with user names and user passwords stored in said centralized database for the client, to determine a user's profile; and
allow the user to manage lease transactions, lease accounts, user accounts, and user profiles on said client system using said browser, wherein the level of management the user is allowed by said server depends on said user's profile.

57. A system in accordance with claim 56 wherein said server configured to rank the plurality of users, according to a User Admin Level, wherein the User Admin Level determines the level of management the user is allowed by said server.

58. A system in accordance with claim 57 wherein the plurality of users includes at least one super user, said server configured to allow said super user to at least one of add users, modify users' User Admin Levels, and inactivate users.

59. A system in accordance with claim 57 wherein the client includes multiple offices, and the plurality of users includes at least one ‘office’ super user, said server configured to allow the ‘office’ super user to at least one of add users, modify users' User Admin Levels, and inactivate users, for only the users within the ‘office’ super user's office.

60. A computer readable medium comprising:
a centralized database having user names, user passwords, and user profiles stored in the database;
a code segment that requires a user to enter a valid user name and a valid user password to access said database;
a code segment that compares an entered user name and an entered user password with user names and user passwords stored in the database to determine a user's profile;
a code segment that provides access to said user accounts and said user profiles such that the user can view and modify said user accounts and said user profiles, wherein the user's level of access to said user accounts and said user profiles is determined by said user's profile.

61. A computer readable medium in accordance with claim 60 wherein the user is at least one of an equipment broker, an internal user, an equipment vendor, and equipment manufacturer, and a customer.

62. A computer readable medium in accordance with claim 60 wherein said user accounts stored in said centralized database include lease account information.

63. A computer readable medium in accordance with claim 62 wherein said code segment that provides access to said user accounts and said user profiles configured to allow the user to view the payment history of a lease account.

64. A computer readable medium in accordance with claim 63 wherein said code segment that provides access to said user accounts and said user profiles configured to allow the user to view the credit rating for of a lease account.

65. A computer readable medium in accordance with claim 60 wherein said code segment that provides access to said user accounts and said user profiles configured to allow the user to search said centralized database for at least one of a business name, application number, transaction number, and status.

66. A computer readable medium in accordance with claim 62 wherein said code segment that provides access to said user accounts and said user profiles configured to process a current payoff on a lease account request initiated by the user, and allow the user to view the current payoff information.

67. A computer program for a network-based system for equipment lease processing and management, the network-based system including a server, a client system, and a centralized database coupled to the server, the server configured to communicate with the client system, said computer program comprising:
a lease application code segment stored in the centralized database and configured to be completed using the client system, the lease application further configured to be submitted to the server using the client system;
a code segment to process the completed lease application using the server; and
a code segment to display on the client system the results of said processing of the completed lease application.

68. A computer program in accordance with claim 67 wherein the centralized database further includes user names, user passwords, and user profiles stored in the database, said computer program further comprising:
a code segment to require the user to enter into the client system a valid user name and a valid user password to access the centralized database and the lease application; and
a code segment to compare the user name and user password entered into the client system with user names and user passwords stored in the centralized database to determine a user's profile.

69. A computer program in accordance with claim 68 further comprising a code segment to allow a user to view on the client system the status of a completed lease application, after the completed lease application has been submitted to the server.

70. A computer program for a network-based system for equipment lease processing and management, the network-based system including a server, at least two client systems, a centralized database coupled to the server, the server configured to communicate with the client system, the centralized database including vendor names, vendor passwords, and vendor profiles stored in the database, said computer program comprising:
a code segment to require the vendor to enter into the client system a valid vendor name and a valid vendor password to access the centralized database and the lease application;
a code segment to compare the vendor name and vendor password entered into the client system with vendor names and vendor passwords stored in the centralized database to determine a vendor's profile;
a lease application code segment stored in the centralized database and configured to be at least partially completed using a first client system, the partially completed lease application further configured to be submitted to the server using the first client system;
a code segment to electronically mail notification to a customer that a vendor has submitted a partially completed least application to the server, wherein the electronic mail notification includes a link configured to access the partially completed lease application and submit a fully completed lease application to the server, using a second client system;
a code segment to allow the customer to validate and complete the partially completed lease application using the second client system; and
a code segment to process the completed lease application using the server.
